(19) United States
(12) Patent Application Publication
(10) Pub. No.: US 2022/0295815 A1
(43) Pub. Date: Sep. 22, 2022

(54) INSTANT COFFEE POWDER

(71) Applicant: SOCIETE DES PRODUITS NESTLE S.A., Vevey (CH)

(72) Inventors: ULRICH KESSLER, Savigny (CH); MARTIN LESER, Bretigny-sur-Morrens (CH); VINCENT DANIEL MAURICE MEUNIER, Epalinges (CH); STEFAN PALZER, Lausanne 26 (CH); ZUZANA SEDIVA, Zurich (CH); ERICH JOSEF WINDHAB, Hemishofen (CH)

(21) Appl. No.: 17/596,134

(22) PCT Filed: Jun. 4, 2020
(86) PCT No.: PCT/EP2020/065558

§ 371 Date: Dec. 3, 2021

(30) Foreign Application Priority Data
Jun. 5, 2019 (EP) 19178519.5

(51) Int. Cl. A23F 5/10; A23F 5/32; A23F 5/36

(52) U.S. Cl. CPC A23F 5/105; A23F 5/32; A23F 5/36

(57) ABSTRACT

The present invention relates to an instant coffee powder, wherein the powder has a closed porosity of 15% to 50%, or 20% to 35%, or 25% to 34%, or 30 to 34%, or about 30%; use of gas hydrates for producing an instant coffee powder; and a method of producing an instant coffee powder.

### FIELD OF THE INVENTION

The present invention relates to an instant coffee powder and to the use of gas hydrates for producing an instant coffee powder.

### BACKGROUND TO THE INVENTION

Unlike coffee beverages prepared from roast and ground coffee, those prepared from instant coffee powders do not usually exhibit a fine foam (crema) on their upper surface when reconstituted with hot water.

This foam is known to positively affect the mouthfeel of the product when consumed and so is highly desired by many consumers. Furthermore, the foam acts to keep more of the volatile aromas within the beverage so that they can be appreciated by the consumer rather than lost to the surrounding environment.

The foamed upper surface in beverages prepared from roast and ground coffee are typically caused by brewing with pressurised water and/or steam. However, for instant coffee powders the foam must be generated by reconstituting the instant coffee powder with water. Thus, to achieve a foam, gas must be entrapped in the instant coffee powder and be released by pouring hot water onto it.

Numerous methods for preparing foaming instant coffee powders have been described (e.g. EP 2 100 514, EP 2 689 668, EP 2 217 086 and US 2013/0230628). However, many foaming instant coffee powders are still lacking insofar as the foam initially produced is not conserved during consumption, or the structure resembles a coarse foam rather than a fine and smooth foam (crema), ultimately desired by consumers. Additionally, there is often insufficient foam (and/or crema) produced.

Moreover, current methods for preparing foaming instant coffee powders typically require energetically demanding mixing and freezing units, necessary for homogenizing gas into viscous liquids and pre-freezing them for the freeze drying. They also typically require high doses of gas and long gas dosing times.

Thus, there is a demand for improved foaming instant coffee powders and improved methods of producing foaming instant coffee powders.

### SUMMARY OF THE INVENTION

The inventors have surprisingly found that gas hydrates (also known as clathrate hydrates) may be used for producing instant coffee powders. The inventors have surprisingly found that an instant coffee powder produced by using gas hydrates may form a foam and/or crema on its upper surface when reconstituted with water.

The inventors have surprisingly found that use of gas hydrates for producing an instant coffee powder requires energetically less demanding mixing and freezing units, lower doses of gas, and shorter gas dosing times than current methods. For example, use of gas hydrates allows highly viscous coffee solution (e.g. 60-63 wt % coffee solids) to be gasified.

The inventors have surprisingly found that CO₂ hydrates may be used to produce an instant coffee powder which forms a crema on its upper surface when reconstituted with water.

Accordingly, in one aspect, the present invention provides use of gas hydrates for gasifying a food product. The gas may be air and/or may comprise one or more of carbon dioxide, nitrogen, nitrous oxide and argon, preferably carbon dioxide and/or nitrogen. Preferably the food product is coffee and/or a coffee solution.

According to another aspect the present invention provides use of gas hydrates for producing an instant coffee powder. The gas may be air and/or may comprise one or more of carbon dioxide, nitrogen, nitrous oxide and argon, preferably carbon dioxide and/or nitrogen.

According to another aspect, the present invention provides a method of producing a coffee slurry comprising gas hydrates, comprising:
(a) providing a first coffee solution;
(b) cooling the first coffee solution; and
(c) pressurising the first coffee solution with gas, to provide a coffee slurry comprising gas hydrates, wherein the gas is air and/or comprises one or more of carbon dioxide, nitrogen, nitrous oxide and argon, preferably carbon dioxide and/or nitrogen.

In some embodiments the first coffee solution is cooled in step (b) to between −10° C. and 10° C., or to between −8° C. and 7° C., or to between −5° C. and 5° C., or to no lower than about −5° C. and/or the gas pressure in step (c) is from 10 to 300 bar, or from 10 to 150 bar, or from 10 to 100 bar, or from 10 to 50 bar, or from 15 to 40 bar, or from 15 to 35 bar, or from 15 to 30 bar (depending wt % of coffee solids in the coffee solution and the identity of the gas). In some embodiments the method comprises cooling the first coffee solution in step (b) to between 0 and 5° C., or to about 3° C.; and pressurising the coffee solution in step (c) with carbon dioxide, preferably at 15-25 bar, or about 20 bar, prior to pressurising the first coffee solution with nitrogen, preferably at 30-300 bar, 30-150 bar, 30-100 bar, 30-50 bar, 30-40 bar or about 35 bar.

In some embodiments the method further comprises a step of distributing the gas hydrate in the coffee slurry.

According to another aspect, the present invention provides a coffee slurry comprising gas hydrates, wherein the gas is air and/or comprises one or more of carbon dioxide, nitrogen, nitrous oxide and argon, preferably carbon dioxide and/or nitrogen. The coffee slurry may be obtained by the above-mentioned method.

In some embodiments the first coffee solution and/or the coffee slurry comprises 10 wt % to 50 wt %, 20 wt % to 40 wt %, or about 30 wt % coffee solids.

In some embodiments the coffee slurry has a viscosity of between 10 mPas and 1Pas for 10 wt % to 50 wt % coffee solids.

In some embodiments the coffee slurry has a viscosity of between 10 and 100 mPas, or between 20 and 100 mPas, or between 30 and 65 mPas, or about 30 mPas or more, and/or about 100 mPas or less. The viscosity of the coffee slurry may be greater than that of the first coffee solution provided in step (a).

In some embodiments the coffee slurry comprises carbon dioxide, preferably 0.5-5 mol/L, 1-5 mol/L, 1-2 mol/L, about 1 mol/L, or about 1.6 mol/L of carbon dioxide; and/or nitrogen, preferably 0.01-0.5 mol/L, 0.02-0.1 mol/L, or about 0.05 mol/L of nitrogen. In some embodiments the coffee slurry has a ratio of gas in the hydrate fraction to gas in the liquid fraction (H:L) of from 1:1 to 5:1, preferably from 2:1 to 3:1.

In some embodiments the coffee slurry comprises 0.5-5 mol/L carbon dioxide, or 1-5 mol/L carbon dioxide, or 1-2 mol/L carbon dioxide, or about 1 mol/L carbon dioxide, or about 1.6 mol/L of carbon dioxide; and 0.01-0.5 mol/L nitrogen, or 0.02-0.1 mol/L nitrogen, or about 0.05 mol/L of nitrogen. In some embodiments the coffee slurry has a ratio of gas in the hydrate fraction to gas in the liquid fraction (H:L) of from 1:1 to 5:1, preferably from 2:1 to 3:1.

In some embodiments the coffee slurry comprises 0.5-5 mol/L carbon dioxide, or 1-5 mol/L carbon dioxide, or 1-2 mol/L carbon dioxide, or about 1 mol/L carbon dioxide, or about 1.6 mol/L of carbon dioxide; or 0.01-0.5 mol/L nitrogen, or 0.02-0.1 mol/L nitrogen, or about 0.05 mol/L of nitrogen. In some embodiments the coffee slurry has a ratio of gas in the hydrate fraction to gas in the liquid fraction (H:L) of from 1:1 to 5:1, preferably from 2:1 to 3:1.

According to another aspect, the present invention provides a method of producing an instant coffee powder comprising:
(a) mixing a coffee slurry comprising gas hydrates with a second coffee solution to provide a coffee slurry/coffee solution mix;
(b) releasing the pressure and/or increasing the temperature of the coffee slurry/coffee solution mix to provide a foamed coffee solution;
(c) drying the foamed coffee solution, preferably by freeze-drying, to provide a dried coffee; and
(d) grinding the dried coffee, to provide an instant coffee powder.

In some embodiments the coffee slurry is obtained by the above-mentioned method or is a coffee slurry comprising gas hydrates as described above.

In some embodiments the second coffee solution comprises 10 wt % to 70 wt %, 30 wt % to 70 wt %, 50 wt % to 70 wt %, 55 wt % to 65 wt %, 60 wt % to 65 wt %, or about 60 wt % coffee solids.

In some embodiments the coffee slurry is added to the second coffee solution under approximately isobaric-isothermal conditions, preferably wherein the approximately isobaric-isothermal conditions are a temperature of between −10° C. and 10° C., or between −8° C. and 7° C., or between −5° C. and 5° C., or to no lower than about −5° C. and/or a gas pressure from 10 to 300 bar, or from 10 to 150 bar, or from 10 to 100 bar, or from 10 to 50 bar, or from 15 to 40 bar, or from 15 to 35 bar, or from 15 to 30 bar (depending wt % of coffee solids in the coffee solution and the identity of the gas).

In some embodiments in the step of releasing the pressure and/or increasing the temperature of the coffee slurry/coffee solution mix, the pressure is released to between 1 bar and 10 bar, or to between 5 bar to 10 bar, and/or the temperature of the coffee slurry/coffee solution mix is increased to between −5° C. and 10° C., or to above 0° C., or about 5° C., or to 10° C. and above. The method may comprise an additional step of fast-freezing the foamed coffee solution, prior to drying the foamed coffee solution.

In some embodiments the coffee slurry reaches an overrun of from 50 to 500%, or from 200 to 400%, or from 250 to 350%, or about 300%.

According to another aspect, the present invention provides an instant coffee powder obtained by the above-mentioned method.

According to another aspect, the present invention provides an instant coffee powder, wherein the powder has a closed porosity of 15% to 50%, or 20% to 35%, or 25% to 34%, or 30% to 34%, or about 30% and/or a foaming porosity of 25% to 34%, or 30 to 34%, or about 30%.

In some embodiments the instant coffee powder has a bimodal closed pore distribution. The bimodal pore distribution may comprise (i) pores with an average diameter of 20 to 100 microns, or 20 to 45 microns, or about 40 microns; and (ii) pores with an average diameter of less than about 20 microns, or 1 to less than 20 microns, or 1-18 microns, or 1-15 microns, or 1-10 microns, or 2-5 microns. In some embodiments (i) contributes 10 to 99% by volume of the total pore volume and/or (ii) contributes 1 to 90% by volume of the total pore volume; and/or (i) contributes 10 to 90% by number of the total pores and/or (ii) contributes 10 to 90% by number of the total pores. The larger pores may consist substantially of open pores; and/or the smaller pores may consist substantially of closed pores

### DESCRIPTION OF DRAWINGS

FIG. 1—Flowchart depicting the basic steps of instant soluble coffee production.

Scheme is adapted from Bhandari, B., N. Bansal, M. Zhang, and P. Schuck: Handbook of Food Powders: Processes and Properties. Elsevier Science, 2013. The sketch depicts an instant coffee powder processing procedure. In the extraction step ground coffee is extracted with water to 20-30 wt % solids. Afterwards, under pressure and high temperatures the extracted coffee is concentrated to viscous slurries with 40 to 50 wt % solids. CO₂ and N₂ are usually added to control the density of the medium for further drying (Clarke, 2003, Coffee Instant, Encyclopedia of Food Sciences and Nutrition, pp. 1493-1498). The present invention provides a method for foaming the concentrated coffee solution with gas hydrates. Afterwards the foamed coffee solution is dried in the dehydration step.

FIG. 2—Solubility curves of CO₂ in coffee solutions.

Solubility curves of CO₂ in 30 and 50 wt % coffee solutions at 4° C. and 10° C. from the current study and at 80° C. and 120° C. for 20 wt % coffee solutions from Wilken, M., K. Fischer, and I. Meier: Experimental Determination of Carbon Dioxide Solubility in 20 mass percent Coffee Aqueous Solution at 80 and 120° C. and Pressures up to 30 bar. Technical report, University Oldenburg, Oldenburg, 1999. The data points were fitted with a polynomial fit resulting in a positive correlation between pressure and solubility.

FIG. 3—Gas hydrate phase diagrams for the coffee system.

Phase diagram for the CO₂ hydrate coffee system compared with the thermodynamic model for pure water-CO₂ and pure 25 and 50 wt % model aqueous sugar solution-CO₂ systems. Experimental gas hydrate points from a T-cycle heating/cooling method and high-pressure DSC method (made from the 30 wt % coffee solution) lie between pure water and the 25 wt % sugar solution. The 25 wt % sugar solution can therefore serve as a model system for 30 wt % coffee solutions.

In (b) the CO₂/N₂ water phase diagram from Kang, S. P., et al., 2001. The Journal of Chemical Thermodynamics, 33(5), pp. 513-521. The numbers in the graph refer to CO₂ composition ratios.

FIG. 4—Rheological properties of coffee solutions not comprising gas hydrates.

In (a) a flow curve profile of viscosity over the shear rate shows Newtonian behaviour for the 30, 40, 50 and 60 wt % coffee solutions. Only the downward shear rate ramp is shown. In (b) a viscosity dependence on temperature is shown for the 30, 40, 50 and 60 wt % coffee solutions. Only the downward ramp is depicted. The upward ramps resembled the plotted ones.

FIG. 5—High-pressure CLAG (Clathrate hydrate slurry generator) reactor processing variables from preparatory experiments of foaming media for different transfer trials.

Coffee slurry generation process variables. Viscosity, density, pressure and temperature over time. Coffee slurries comprising gas hydrates containing CO₂ (labelled as CO₂ H in legend) and CO₂ and N₂ (labelled as CO₂:N₂=0.54 in legend) as well as coffee solutions saturated with gas (labelled as CO₂ diss and N₂ diss) were formed in the CLAG reactor.

All experiments were formed from 30 wt % coffee solutions. The induction time (first appearance of gas hydrates) are labelled on the time axis. Abbreviations diss stand for dissolved and H for hydrate.

FIG. 6—Processing variable profiles during transfer of coffee slurries

Operational variable profiles during transfer of the 30% coffee CO2 hydrate slurry in (a) compared with dissolved nitrogen in a 30 wt % coffee slurry in (b) transferred into a 60 wt % coffee concentrate. The pressure on the loop decreases as the material from the loop is dosed into the EGLI Line.

Loop: refers to the CLAG side stream (i.e. coffee slurry). Main: refers to EGLI, main stream. Tᵢₙ=temperature inlet. Tᵢₙ=Tₗₒₒₚ, i.e. isothermal transfer, where T>0° C. T₂=temperature between surface scraped heat exchanger 1 and 2. Tₒᵤₜ=temperature outlet.

FIG. 7—Reconstituted ground and sieved instant coffee powders and their properties.

In (a) samples made with a transfer of 30 wt % coffee CO₂ hydrate slurries and in (b) made with a transfer of 30 wt % coffee mixed CO₂/N₂ hydrate slurries with 0.54 CO₂/N₂ ratio and 0.48 CO₂:N₂ ratio. Closed porosity (CP) and the overrun (OR) are denoted below the reconstituted instant coffee powder images.

FIG. 8—Scanning electron microscopy.

Scanning electron microscopy of a granule from a crema-producing reference instant coffee powder (made with nitrogen gas) compared with a granule of instant coffee powder according to the present invention (made with a CO₂/N₂ gas hydrate).

FIG. 9—Cryo-Scanning electron microscopy images.

Cryo-Scanning electron microscopy images of microstructure of the frozen foamed coffee solution samples before freeze drying. The samples were acquired at a 2000× and 250× magnification and an accelerating voltage of 2 kV.

FIG. 10—Schematic of a method of producing an instant coffee powder according to the present invention.

The method of the present invention may comprise:
(a) providing a first coffee solution;
(b) cooling the first coffee solution;
(c) pressurising the first coffee solution with gas, to provide a coffee slurry comprising gas hydrates (side stream), preferably wherein the gas is air and/or comprises one or more of carbon dioxide, nitrogen, nitrous oxide and argon, preferably the gas comprises carbon dioxide and/or nitrogen;
(d) mixing the coffee slurry comprising gas hydrates (side stream) with a second coffee solution (main stream) to provide a coffee slurry/coffee solution mix;
(e) releasing the pressure of the coffee slurry/coffee solution mix to provide a foamed coffee solution;
(f) fast freezing the foamed coffee solution to provide a stabilised foamed coffee solution (e.g. in a solid coffee block format);
(g) drying the stabilised foamed coffee solution, preferably freeze-drying, to provide a dried coffee (e.g. in a dried solid coffee block format); and
(h) grinding the dried coffee, to provide an instant coffee powder.

### DETAILED DESCRIPTION

### Gas Hydrate

“Gas hydrates” are also known as clathrate hydrates or water clathrates. Gas hydrates are crystalline water-based solids physically resembling ice, in which gases are trapped inside 3D “cages” of hydrogen bonded water molecules.

Most low molecular weight gases, including O₂, H₂, N₂, N₂O, CO₂, CH₄, H₂S, Ar, Kr, Ne, He and Xe, will form hydrates at suitable temperatures and pressures. Gas hydrates may be formed by providing a suitable gas and reducing the temperature and/or increasing the gas pressure of a suitable solution (e.g. a coffee extract solution).

The identity of the gas is not particularly limited. Any gas suitable for producing an instant coffee powder and/or suitable for use in industrial food processes may be used. For example, the gas may be air and/or may comprise one or more of carbon dioxide, nitrogen, nitrous oxide and argon. In preferred embodiments the gas comprises carbon dioxide and/or nitrogen. In some embodiments the gas hydrates comprise substantially the same gas. In some embodiments the gas is a pure gas (for example comprising 99% or more, or 99.9% or more, or 100% of a single gas). In preferred embodiments the gas hydrates are CO₂ or N₂ hydrates.

Suitable temperatures and gas pressures will vary depending on the gas and the food product. For example, a CO₂ hydrate may be formed in a 30 wt % coffee solution at about 6° C. and about 30 bar, or in a 50 wt % coffee solution at about 4° C. and about 30 bar. A lower temperature solution will require a lower gas pressure, and vice versa a higher temperature solution will require a higher gas pressure. For example, a CO₂ hydrate may be formed in a 30 wt % coffee solution at about 6° C. and about 30 bar, or at about −4° C. and about 10 bar. There may be a need to avoid conditions in which ice forms and/or in which the gas condenses. The freezing point depression (i.e. temperature where pure ice is formed) will depend on the wt % of coffee solids in a coffee solution. Gas hydrates can form in such conditions, however they are complex to treat and may form blockages. For example, −4° C. is about the freezing point depression for 30 wt % coffee solution, so lower temperatures should not be used for forming gas hydrates in a 30 wt % coffee solution. For example, the second quadruple point (the point where liquid, hydrate, vapour and condensed gas phases meet) is about 8-10° C. and 44 bar for CO₂ in a 30 wt % coffee solution. Therefore, CO₂ will be a liquid at lower temperatures and/or higher pressures. The temperature and gas pressure may be varied depending on the desired viscosity and/or desired gas concentration.

Thus, the temperature and pressure required to form gas hydrates are interdependent and will vary depending on the gas and the solution (e.g. the wt % of solids in the coffee solution). Exemplary conditions for forming CO₂ hydrates in a 30 wt % coffee solution are −3 to 7.8° C. and 10-38 bar, or about 10 bar or more. Exemplary conditions for forming N₂ hydrates in a 30 wt % coffee solution are −2.5° C. to 5.5° C. and 140 to 285 bar. Exemplary conditions for forming N₂O hydrates in a 30 wt % coffee solution are about 0 to 9° C. and 12 to 28 bar. To form hydrates at lower pressures, lower temperatures must be used.

In some embodiments the gas hydrates are formed by a first gas prior to introducing one or more further gases. Thus, the final gas hydrates may contain two or more gases i.e. the gas hydrates may be mixed gas hydrates. For example, in mixed CO₂/N₂ hydrates, CO₂ allows N₂ to get embedded at lower pressures by leaving small hydrate cages unoccupied. First the CO₂ hydrate may be prepared at lower pressures, then N₂ may be added at higher pressures. Similar methods may be used for any combination of suitable gases. In preferred embodiments the gas hydrates are mixed CO₂/N₂ hydrates. The molar fraction of CO₂ trapped in the CO₂/N₂ hydrates may be from 0.1 to 0.99, or from 0.5 to 0.99, or from 0.8 to 0.99, or from 0.9 to 0.99, or from 0.95 to 0.99, or about 0.97. In other embodiments the gas hydrates are N₂O/N₂ hydrates (Yang, Y., et al., 2017. Environmental science & technology, 51(6), pp. 3550-3557) or N₂O/CO₂ hydrates or N₂O/CO₂/N₂ hydrates.

In preferred embodiments CO₂ hydrates (or alternatively N₂O or CO₂/N₂O hydrates) are formed prior to introduction of nitrogen gas. For example, the CO₂ hydrates may be formed with carbon dioxide introduced at 10-50 bar, 15-25 bar, or about 20 bar and at −3 to 7.8° C. or about 2° C. (e.g. 1-2° C. and 20-30 bar, or about 20 bar or more). Once a small amount of CO₂ hydrates form (as shown by a drop in pressure) nitrogen may be introduced to increase the total gas pressure. The amount of nitrogen introduced (i.e. the CO₂:N₂ ratio) and the required pressure will vary depending on the desired ratio of CO₂/N₂ in the gas hydrates. The total gas pressure may be increased to 10-300 bar, 10-200 bar, 20-300 bar, 20-200 bar, 20-100 bar, 20-50 bar, 30-40 bar or about 35 bar, at −5° C. to 5° C., at 0 to 5° C. or about 2° C. (compare with Kang, S. P., et al., 2001. The Journal of Chemical Thermodynamics, 33(5), pp. 513-521). The molar fraction of CO₂ (in the final gas mix) for forming the mixed CO₂/N₂ hydrates may be from 0.1 to 0.9, or from 0.2 to 0.8, or from 0.4 to 0.6, or from 0.47 to 0.54, or about 0.54. The fraction of CO₂ (in the final gas mix) should be such that CO₂ does not condense. CO₂ will condense at a broad range of pressure and temperature conditions, depending on the vapour pressure. For example, CO₂ will condense at about 8-10° C. and 44 bar in a 30 wt % coffee solution.

As described above, the temperature and pressure required to form gas hydrates are interdependent and will vary depending on the gas and the solution (e.g. the wt % of solids in the coffee solution). Exemplary conditions for forming mixed CO₂/N₂ hydrates in a 30 wt % coffee solution are a molar fraction of CO₂ in the gas mix of about 0.54, wherein CO₂ is introduced at about 20 bar and at 0 to 5° C. or about 2° C., prior to introducing N2 to reach 35 bar of total gas pressure. If higher amounts of N2 are desired in the mixed hydrates, a lower molar fraction of CO₂ may be used in combination with a higher pressure (and/or lower temperature), for example a molar fraction of CO₂ of about 0.1 and pressures of about 100 to 130 bar at around 0° C. may be used to form CO₂/N₂ hydrates with a higher amount of N2 (see FIG. 3b).

The gas hydrates may be decomposed by increasing the temperature and/or decreasing the pressure. Preferably, the gas hydrates may be decomposed by increasing the temperature and decreasing the pressure; or by decreasing the pressure only. Consequently, no gas hydrates may be present in the foamed food product (e.g. coffee) prior to drying. For example, no gas hydrates may be present in the foamed coffee solution, the stabilised foamed coffee solution, the dried coffee, or in the instant coffee powder.

### Use of Gas Hydrates for Gasifying a Food Product

In one aspect, the present invention provides use of gas hydrates for gasifying a food product. The gas may be air and/or may comprise one or more of carbon dioxide, nitrogen, nitrous oxide and argon, preferably carbon dioxide and/or nitrogen. In preferred embodiments the food product has a viscosity of between 100 mPas and 10 Pas, or 500 mPas and 10 Pas, or 1 Pas and 10 Pas, or 1 Pas and 5 Pas.

Food products include, for example, liquid products (e.g. ready-to-drink products, ready-to-heat products, liquid concentrates, beverages), such as coffee, coffee chicory, coffee cereal chicory mixtures, cocoa, tea, nutritional beverages, toppings, desserts, sauces, and soups; powdered products, such as instant coffee powders, instant cocoa powders, instant tea powders, nutritional beverage powders, instant topping powders, instant dessert powders, instance sauce powders, instant soup powders, bread mix, cake mix, pastry mix, waffle mix, and pizza crust mix; and frozen products. Preferably the food product is coffee, a coffee solution and/or an instant coffee powder.

The present invention provides a method for foaming a food product. The method comprises:
(a) forming gas hydrates in a first portion of the food product to provide a food product slurry comprising gas hydrates;
(b) mixing the food product slurry comprising gas hydrates with a second portion of the food product to provide a food product slurry/food product mix; and
(c) releasing the pressure and/or increasing the temperature of the food product slurry/food product mix to provide a foamed food product

Preferably the first portion of the food product is 1 to 20%, or 2 to 15%, or 5 to 15%, or 5-10% by volume of the food product and the second portion of the food product is the remainder of the food product.

The gas may be air and/or may comprise one or more of carbon dioxide, nitrogen, nitrous oxide and argon, preferably carbon dioxide and/or nitrogen. Preferably the food product is a coffee solution.

In preferred embodiments the food product has a viscosity of between 100 mPas and 10 Pas, or 500 mPas and 10 Pas, or 1 Pas and 10 Pas, or 1 Pas and 5 Pas. The viscosity may be determined by any method known to those of skill in the art, for instance by rheometer. Preferably the viscosity is determined at a shear rate of 100 s⁻¹ and a temperature of 7° C.

Advantageously, mixing gas into a food product in a solid form (e.g. in a food product comprising gas hydrate) facilitates the mixing of the gas in the food product and/or decreases the length of time required to gasify the food product and/or reduces the energy required to gasify the food product.

### Coffee Slurry Comprising Gas Hydrates

A “coffee solution” according to the present invention is a solution comprising soluble coffee components. The coffee solution may also comprise non-soluble coffee components and/or other non-coffee components, and/or such components in suspension. A “coffee slurry” according to the present invention is a coffee solution which comprises dispersed gas hydrates.

A coffee solution for use in the present invention may be extracted from roasted coffee beans or coffee grounds. The roasted coffee beans or coffee grounds may be extracted by any method known to those of skill in the art, for example hot water extraction, vacuum evaporation, centrifuge inspissation or freeze concentration (Bhandari et al. 2013 Handbook of Food powders; processes and properties). Accordingly, the coffee solution may be a coffee extract solution.

The present invention provides a method for producing a coffee slurry comprising gas hydrates. The method comprises:
(a) providing a first coffee solution;
(b) cooling the first coffee solution; and
(c) pressurising the first coffee solution with gas, to provide a coffee slurry comprising gas hydrates, wherein the gas comprises air and/or one or more of carbon dioxide, nitrogen, nitrous oxide and argon, preferably carbon dioxide and/or nitrogen.

The method may further comprise a step of distributing the gas hydrate in the coffee slurry. The gas hydrate may be distributed during and/or after formation. Preferably the gas hydrate is distributed by mixing the coffee slurry e.g. by using a rotating device a static mixer or a pin mixer to effect mixing. The gas hydrate may be mixed in a scraped surface heat exchanger (SSHE) and/or through a pump conveying action.

The first coffee solution may be any suitable coffee solution, for example a coffee solution suitable for producing an instant coffee powder. Preferably the first coffee solution comprises 10 wt % to 50 wt %, 20 wt % to 40 wt %, 25 wt % to 35 wt %, 30 wt % to 35 wt %, or about 30 wt % coffee solids. Preferably the first coffee solution has a viscosity of between 10 mPas and 10 Pas, or 10 mPas and 2.5 Pas, or 10 mPas and 1 Pas, or 10 mPas and 100 mPas, or between 20 and 100 mPas, or between 20 and 60 mPas, or about 20 mPas or more and/or about 100 mPas or less. The viscosity will be interdependent on the wt % of coffee solids, i.e. a higher wt % will result in a higher viscosity (see FIG. 4). For instance, a 60 wt % coffee solution may have a viscosity of around 2.3 Pas at 30 bar, 7° C. and 100s⁻¹ shear rate, whilst a 30 wt % coffee solution may have a viscosity of around 10-20 mPas at 30 bar, 7° C. and 100s⁻¹ shear rate. The viscosity is also dependent on the temperature, the lower the temperature, the higher the viscosity. The viscosity may be determined by any method known to those of skill in the art, for instance by rheometer. For example, the viscosity may be determined at a shear rate of 100 s⁻¹ and a temperature of 7° C. for coffee solutions not comprising gas hydrates.

The temperature and pressure required to form gas hydrates are interdependent and will vary depending on the gas and the solution (e.g. the wt % of solids in the coffee solution). For example, FIG. 3 provides a phase diagram for formation of CO₂ hydrate in a coffee solution with 30 wt % and 50 wt %. There may be a need to avoid conditions in which ice forms and/or in which the gas condenses. The freezing point depression will depend on the wt % of coffee solids in a coffee solution. For example, a 30wt % coffee solution has a freezing point temperature of about −4° C. and a 60wt % coffee solution has a freezing point of about −16° C.

For example, the coffee solution may be cooled in step (b) to between −15° C. and 15° C., or to between −10° C. and 12° C., or to between −10° C. and 10° C., or to between −10° C. and 8° C., or to between −8° C. and 7° C., or to between −5° C. and 5° C., or to no lower than about −7° C., −5° C. or −4° C., depending on the gas, coffee solution and gas pressure. The gas pressure in step (c) may be from 10 to 500 bar, 10 to 300 bar, 10 to 200 bar, 10 to 150 bar, 10 to 100 bar, 10 to 50 bar, or from 15 to 40 bar, or from 15 to 35 bar, or from 15 to 30 bar, depending on the gas, coffee solution and temperature. Preferably, when a CO₂ hydrate is desired a 30 wt % coffee solution is cooled to −3 to 7.8° C. and 10-38 bar, or about 10 bar or more. Preferably, when a N₂ hydrate is desired then a 30 wt % coffee solution is cooled to −2.5° C. to 5.5° C. and pressurised with N₂ to 140 to 285 bar. Preferably, when a N₂O hydrate is desired then a 30 wt % coffee solution is cooled to about 0 to 9° C. and pressurised with N₂O to 12 to 28 bar. To form hydrates at lower pressures, lower temperatures must be used. Preferably, when a CO₂/N₂ mixed hydrate is desired the first coffee solution is cooled to about −3 to 2° C. and pressurised to about 20 bar with CO₂, prior to pressurising to about 35 bar with N₂ (and a molar fraction of CO₂ of about 0.54). Alternatively, when a CO₂/N₂ mixed hydrate with a high amount of N₂ is desired the first coffee solution is cooled to about −3 to 2° C. and pressurised to about 20 bar with CO₂, prior to pressurising to about 100 to 300 bar with N₂ (achieving a molar fraction of CO₂ of about 0.1 or less).

The coffee slurry comprising gas hydrates according to the present invention may comprise 10 wt % to 50 wt %, 20 wt % to 40 wt %, 25 wt % to 35 wt %, 30 wt % to 35 wt %, or about 30 wt % coffee solids. For example, the coffee slurry may be produced from a first coffee solution comprising 10 wt % to 50 wt %, 20 wt % to 40 wt %, 25 wt % to 35 wt %, 30 wt % to 35 wt %, or about 30 wt % coffee solids.

The coffee slurry comprising gas hydrates may have a viscosity of between 10 mPas and 100 mPas, or between 20 and 100 mPas, or between 20 and 60 mPas, or about 20 mPas or more, and/or about 100 mPas or less. The viscosity of the coffee solution will be increased by formation of the gas hydrates. Thus, the formation of the gas hydrates may be monitored by measuring the viscosity of the coffee slurry. Preferably the viscosity of the coffee slurry is greater than the coffee solution provided in step (a), for example 2-4 times greater. The viscosity may be determined by any method known to those of skill in the art, for example by a rheometer or a flow meter. For example, the viscosity may be determined at a shear rate of 100 s⁻¹ and a temperature of 1° C. for coffee slurries comprising gas hydrates.

The coffee slurry may comprise one or more of carbon dioxide, nitrogen, nitrous oxide and argon, preferably carbon dioxide and/or nitrogen. The coffee slurry may comprise 0.01-7.5 mol/L, 0.1-7.5 mol/L, 1-5 mol/L, 1-2 mol/L, or about 1.5 mol/L of gas. In some preferred embodiments, the coffee slurry comprises carbon dioxide, preferably 0.5-5 mol/L, 1-5 mol/L, 1-2 mol/L, or about 1.6 mol/L. In some other preferred embodiments, the coffee slurry comprises carbon dioxide, preferably 0.5-5 mol/L, 0.5-2 mol/L, or about 1 mol/L; and nitrogen, preferably 0.01-5 mol/L, 0.01-2 mol/L, 0.01-1 mol/L, 0.01-0.5 mol/L, 0.02-0.1 mol/L, or about 0.05 mol/L. The amount of gas refers to the total amount of gas in the coffee slurry, i.e. in both the hydrate fraction and in the liquid fraction. The amount of gas may be measured by any method, for example chromatography, PIV, FBRP, optical methods, piezo electric sensors, impedance, or conductance measurements.

The coffee slurry may have a ratio of gas in the hydrate fraction to gas in the liquid fraction (H: L) of from 1:1 to 5:1, preferably from 2:1 to 3:1. For example, the coffee slurry may comprise about 1 mol/L of gas trapped in hydrate form and about 0.5 mol/L dissolved gas. The H:L ratio may be determined by any method, for example chromatography, Raman spectroscopy, x-ray scattering, and/or modelling. Preferably, the majority of the gas is trapped in the gas hydrates.

### Method of Producing an Instant Coffee Powder

The present invention provides a method for producing a dried coffee. The method comprises:
(a) mixing a coffee slurry comprising gas hydrates with a second coffee solution to provide a mixture of these (i.e. a coffee slurry/coffee solution mix);
(b) releasing the pressure and/or increasing the temperature of the coffee slurry/coffee solution mix to provide a foamed coffee solution; and
(c) drying the foamed coffee solution, preferably freeze-drying, to provide a dried coffee.

The present invention provides a method for producing an instant coffee powder. The method comprises:
(a) mixing a coffee slurry comprising gas hydrates with a second coffee solution to provide a coffee slurry/coffee solution mix;
(b) releasing the pressure and/or increasing the temperature of the coffee slurry/coffee solution mix to provide a foamed coffee solution;
(c) drying the foamed coffee solution, preferably freeze-drying, to provide a dried coffee; and
(d) grinding the dried coffee, to provide an instant coffee powder.

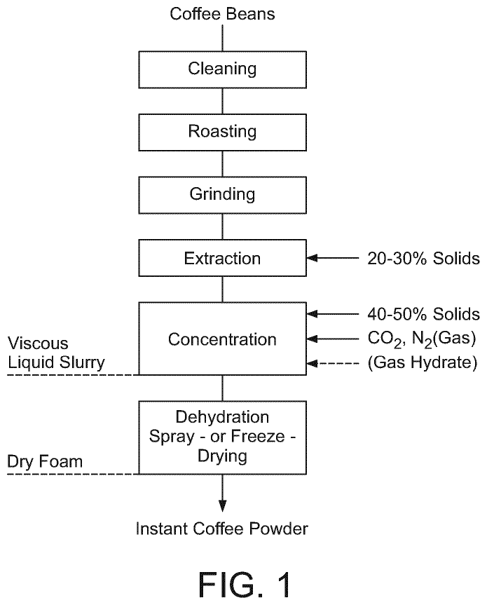

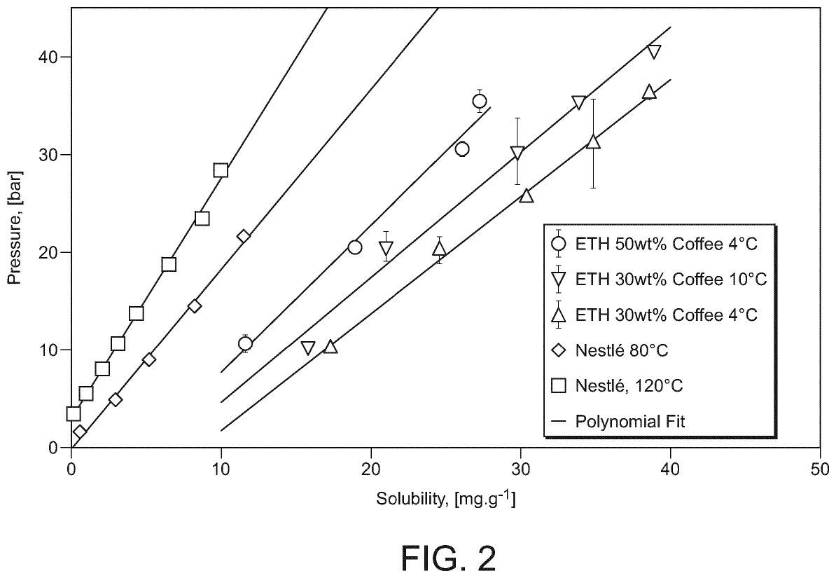

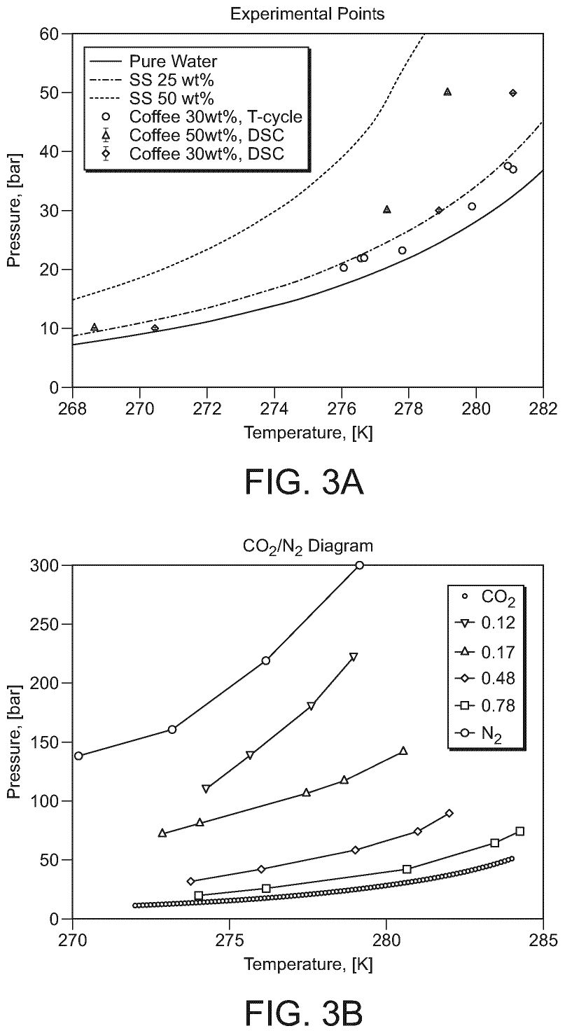

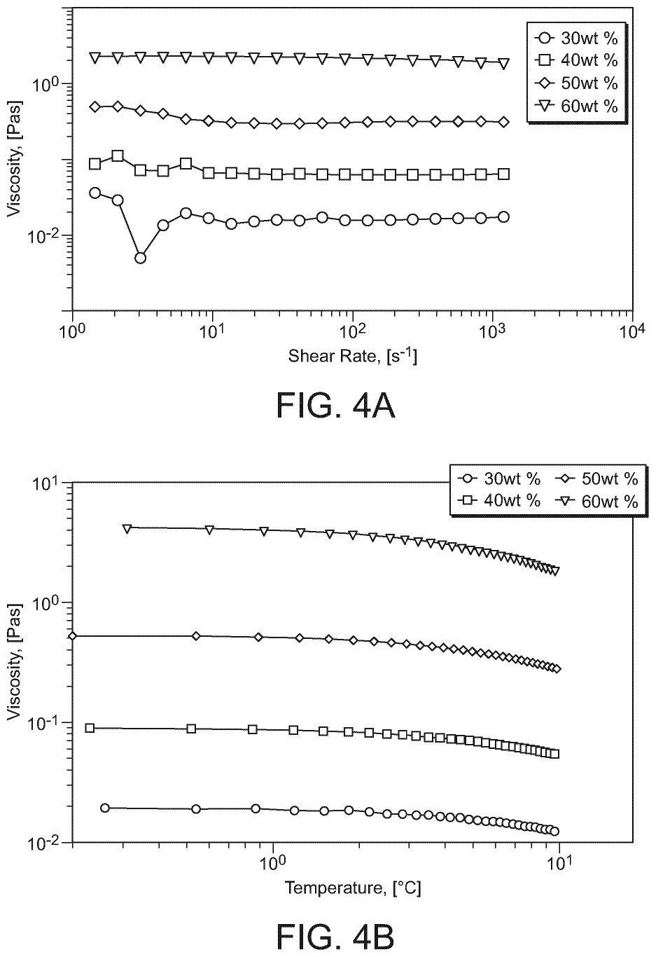

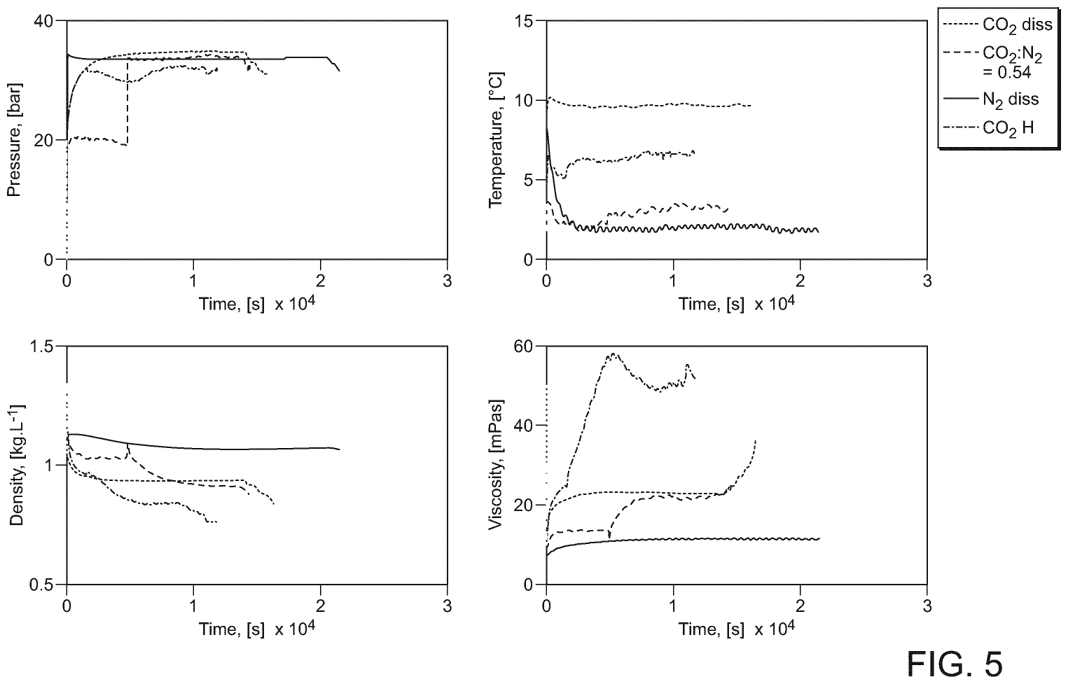

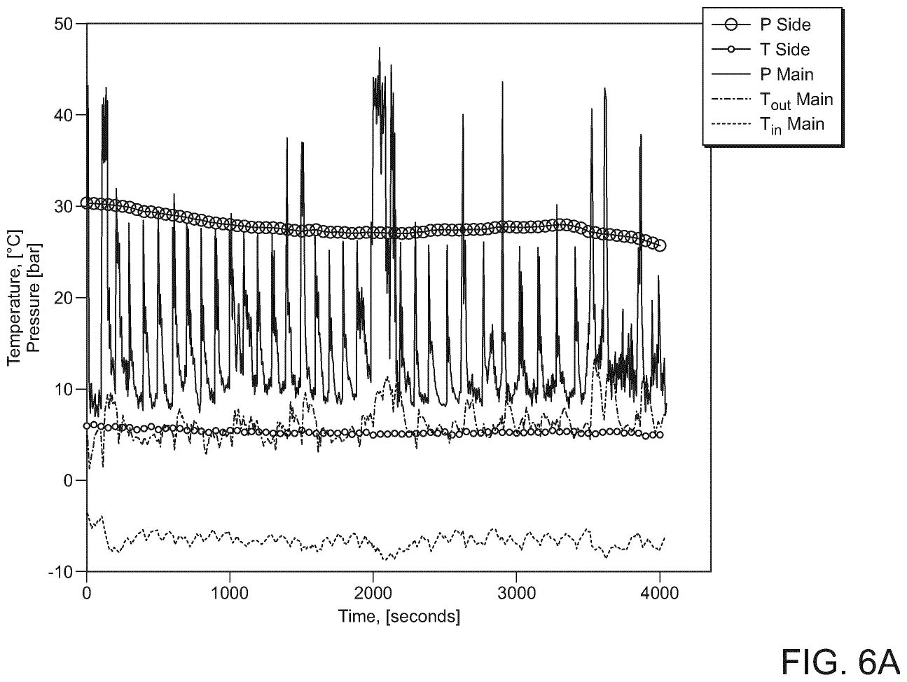

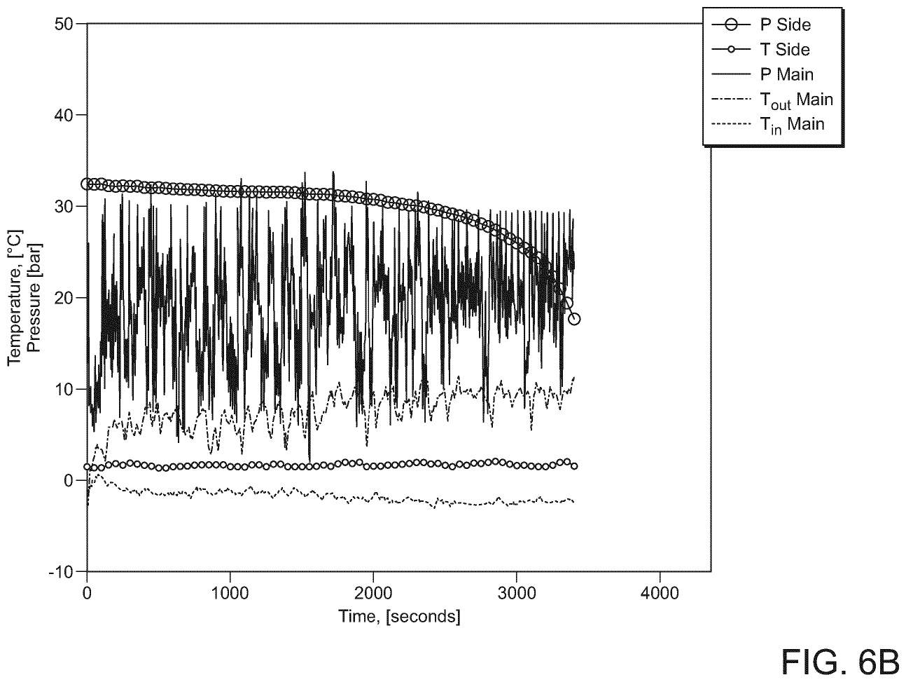

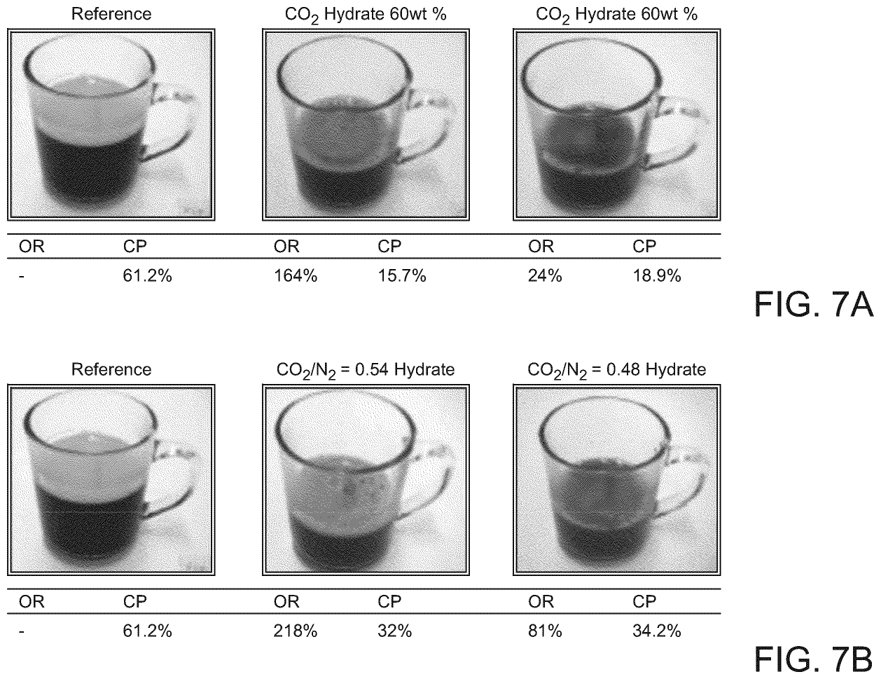

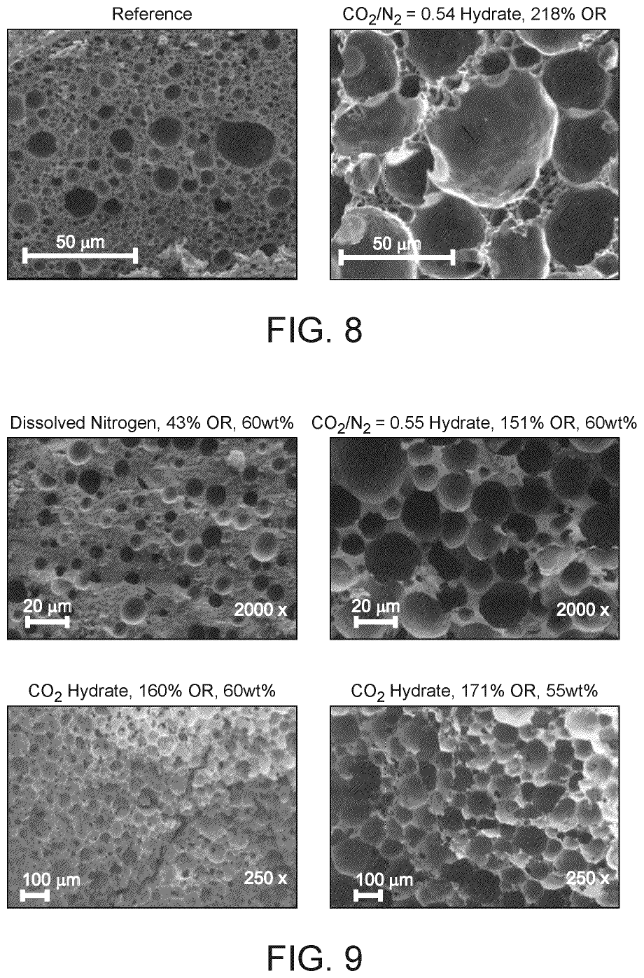

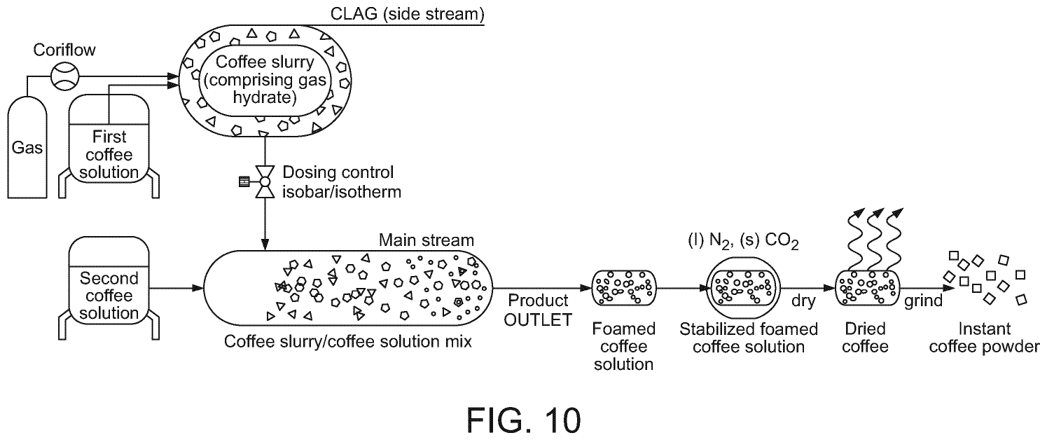

The basic steps of instant soluble coffee production are shown in FIG. 1. The method may further comprise one or more of the steps outlined in FIG. 1. A method according to the present invention is shown in FIG. 10. The method may further comprise one or more of the steps outlined in FIG. 10.

Advantageously, mixing gas into a coffee solution in a solid form (e.g. in a coffee slurry comprising gas hydrates) facilitates the mixing of the gas in the coffee solution and/or decreases the length of time required to gasify the solution and/or reduces the energy required to gasify the solution.

In the method for producing an instant coffee powder according to the present invention, the coffee slurry may be produced by a method herein described. The coffee slurry may be produced in a side stream (i.e. clathrate hydrate slurry generator (CLAG)).

In the method for producing an instant coffee powder according to the present invention, the second coffee solution may be produced by any method known to those of skill in the art. The second coffee solution may be present in a main stream. Preferably, the second coffee solution does not comprise gas hydrates. The second coffee solution may comprise 10 wt % to 70 wt %, 30 wt % to 70 wt %, 50 wt % to 70 wt %, 55 wt % to 65 wt %, 60 wt % to 65 wt %, or about 60 wt % coffee solids. Preferably the second coffee solution has a higher wt % of coffee solids than the coffee slurry (i.e. the first coffee solution), for example the coffee slurry (and first coffee solution) may comprise about 30 wt % coffee solids and the second coffee solution may comprise about 60 wt % coffee solids. The second coffee solution may have a viscosity of between 10 mPas and 10 Pas, or 10 mPas and 2.5 Pas, or 10 mPas and 1 Pas, or 10 mPas and 100 mPas, or between 20 and 100 mPas, or between 20 and 60 mPas, or about 20 mPas or more and/or about 100 mPas or less. The viscosity will be interdependent on the wt % of coffee solids, i.e. a higher wt % will result in a higher viscosity (see FIG. 4). For instance, a 60 wt % coffee solution may have a viscosity of around 2.3 Pas at 30 bar, 7° C. and 100s⁻¹ shear rate, whilst a 30 wt % coffee solution may have a viscosity of around 10-20 mPas Pas at 30 bar, 7° C. and 100s⁻¹ shear rate. The viscosity is also dependent on the temperature, the lower the temperature, the higher the viscosity. The viscosity may be determined by any method known to those of skill in the art, for instance by rheometer. Preferably the viscosity is determined at a shear rate of 100 s⁻¹ and a temperature of 7° C.

The coffee slurry (side stream) and the second coffee solution (main stream) may be mixed by adding the coffee slurry to the second coffee solution, i.e. by adding the side stream to the main stream. The mixing of the side stream with the main stream produces a coffee slurry/coffee solution mix. Preferably the coffee slurry/coffee solution mix remains in the main stream until the end of mixing. In some embodiments the side stream rate is 5-200 ml/min, or 10-100 ml/min, or about 15 ml/min and the main stream rate is 100-500 ml/min or 100-200 ml/min, or about 170 ml/min. For example, when the coffee slurry comprises a CO₂ hydrate the side stream may be added at a rate of 10-20 ml/min into a 150-200 ml/min main stream;

and when the coffee slurry comprises a CO₂/N₂ hydrate the side stream may be added at a rate of 80-100 ml/min into a 150-200 ml/min main stream. In some embodiments the ratio of the side stream rate:main stream rate is less than 1, or 0.05 to 0.5, or 0.05 to 0.1, or about 0.08.

In some embodiments the coffee slurry is added to the second coffee solution by dosing (i.e.

by adding a specific amount (volume) of the coffee slurry at discrete time intervals). In some embodiments the amount (volume) of coffee slurry added is 1 to 1000cm³, 1 to 100cm³, 1 to 50 cm³, 10 to 50 cm³, or 5 to 20 cm³, or about 15 cm³. In some embodiments the coffee slurry is added every 1 to 1000 seconds, or every 5 to 200 seconds, or every 60 to 100 seconds. In some embodiments 10 to 50 cm³ is added every 60 to 100 seconds.

In some embodiments the amount (volume) of coffee slurry added and/or the rate is sufficient to provide 0.001 to 1 mol/min, or 0.02 to 0.1 mol/min of gas to the second coffee solution. For example, when the coffee slurry comprises a CO₂ hydrate the volume of slurry added and the rate may be such that 0.02 to 0.1 mol/min of CO₂ is provided; and when the coffee slurry comprises a CO₂/N₂ hydrate the volume of slurry added and the rate may be such that 0.02 to 0.1 mol/min of CO₂ and 0.001 to 0.005 mol/min of N2 is provided.

In some embodiments the coffee slurry (side stream) and the second coffee solution (main stream) are mixed and/or the side stream is added to the main stream under close to (i.e. approximately or about) isobaric-isothermal conditions, preferably isobaric-isothermal conditions. “Isobaric-isothermal conditions” according to the present invention are those in which mixing is at a constant temperature and constant gas pressure. Preferably the isobaric-isothermal conditions are the same as the conditions of the coffee slurry (side stream) prior to mixing, i.e. the isobaric-isothermal conditions refer to the pressure and temperature at the inlet where the side stream enters the main stream. Approximately isobaric-isothermal conditions may be within ±2° C. and ±5 bar of isobaric-isothermal conditions. Preferably the temperature and gas pressure are suitable for the formation and/or retention of the gas hydrates, as described above. Accordingly, the temperature may be between −15° C. and 15° C., or between −10° C. and 12° C., or between −10° C. and 10° C., or between -10° C. and 8° C., or between -8° C. and 7° C., or between −5° C. and 5° C., or no lower than about −7° C., -5° C. or -4° C., depending on the gas, coffee solution and gas pressure, and/or the gas pressure may be from 10 to 500 bar, 10 to 300 bar, 10 to 200 bar, 10 to 150 bar, 10 to 100 bar, 10 to 50 bar, from 15 to 40 bar, or from 15 to 35 bar, or from 15 to 30 bar, depending on the gas, coffee solution and temperature. The temperature and pressure required to form and/or retain gas hydrates are interdependent and will vary depending on the gas and the solution (e.g. the wt % of solids in the coffee solution). In preferred embodiments the coffee slurry and the second coffee solution are mixed at about 10-38 bar, or about 10 bar or more pressure and/or -3 to 7.8° C. (wherein the coffee slurry comprises a CO₂ hydrate). In other embodiments the coffee slurry and the second coffee solution are mixed at about 140 to 285 bar pressure and/or about −2.5° C. to 5.5° C. (wherein the coffee slurry comprises a N2 hydrate). In preferred embodiments the coffee slurry and the second coffee solution are mixed at about 35 bar CO₂/N₂ total gas pressure and/or 1-5° C., or about 3° C. (wherein the coffee slurry comprises a CO₂/N₂ mixed hydrate). In some embodiments the coffee slurry (side stream) and the second coffee solution (main stream) are mixed under the same temperature and/or pressure used to produce the coffee slurry comprising gas hydrates.

According to the present invention, the coffee slurry/coffee solution mix is a foamed coffee solution after releasing the pressure and/or increasing the temperature of the coffee slurry/coffee solution mix. Preferably the dosing of the coffee slurry and/or the mixing of the coffee slurry and the second coffee solution continues until the coffee slurry/coffee solution mix (i.e. foamed coffee solution) reaches an overrun of from 50 to 500%, or from 100 to 500%, or from 100 to 400%, or from 150 to 400%, or from 200 to 400%, or from 250 to 350%, or about 300%. As used herein the “overrun” is the increase in volume of the coffee solution, which can be determined by any method known to those of skill in the art. In some embodiments after reaching the desired overrun (e.g. from 50 to 500%, or from 100 to 500%, or from 150 to 400%, or from 100 to 400%, or from 200 to 400%, or from 250 to 350%, or about 300%) the side stream (coffee slurry) is added continuously at a constant dosing rate to the main stream (second coffee solution) to maintain the desired overrun, for example at a dosage rate sufficient to provide 0.001 to 1.5 mol/min, or 0.02 to 0.1 mol/min of gas to the second coffee solution. In some embodiments the mixing and/or dosing continues until the coffee slurry/coffee solution mix comprises 0.01-7.5 mol/L, 0.1-7.5 mol/L, 0.5-2 mol/L, or about 1 mol/L of gas.

In some embodiments the method comprises an additional step of releasing the pressure and/or increasing the temperature of the coffee slurry/coffee solution mix to provide a foamed coffee solution. Preferably, the method comprises an additional step of increasing the temperature and decreasing the pressure or an additional step of decreasing the pressure only (i.e. the temperature is not increased). Preferably this step decomposes any remaining gas hydrates and releases the gas in the coffee slurry/coffee solution mix. The temperature and pressure required to decompose gas hydrates are interdependent and will vary depending on the gas and the solution (e.g. the wt % of solids in the coffee slurry/coffee solution mix). The gas pressure and temperature will thus depend on the identity of the gas hydrates. The gas pressure may be released (optionally in combination with increasing the temperature). In some embodiments, the gas pressure may be lowered to between 1 bar and 10 bar, or to between 5 bar to 10 bar. The temperature may be increased (optionally in combination with lowering the gas pressure). In some embodiments the temperature of the coffee slurry/coffee solution mix may be increased to above 10° C., above 15° C., or above 20° C. In some embodiments the temperature of the coffee slurry/coffee solution mix may be increased to between −5° C. and 10° C., between −5° C. and 5° C., between 0° C. and 10° C., between 0° C. and 5° C., above about 0° C., or about 5° C. in combination with lowering the gas pressure. Preferably the gas pressure is released (i.e. the temperature is not increased). For example, for CO₂ (or mixed CO₂) hydrates in a 30 wt % coffee solution the gas pressure may lowered below about 10 bar (e.g. 1-10 bar, or 1-5 bar) at a temperature of 1-2° C., or below 20 bar at a temperature of 5-6° C. For example, for N₂ hydrates in a 30 wt % coffee solution the gas pressure may be lowered below about 135 bar (e.g. 1-100 bar, 1-50 bar, 1-20 bar) at a temperature of −2.5° C. to 5.5° C.

In some embodiments the method of producing the instant coffee powder may comprise an additional step of fast-freezing the foamed coffee solution, prior to drying, to provide a stabilised foamed coffee solution. In preferred embodiments the stabilised foamed coffee solution is in a solid coffee block format. The fast-freezing may stabilize the foam microstructure of the foamed coffee solution by avoiding any further gas bubble expansion or coalescence. Any fast-freezing method known to those of skill in the art may be used. In some embodiments the foamed coffee solution is fast-frozen to about −196° C., or about −78° C., or −196° C. to −40° C., or −80° C. to −40° C., or −80° C. to −65° C., preferably about −60° C. For example, if the fast-freezing method uses liquid nitrogen to stabilise the foamed coffee solution, then the solution may be fast-frozen to about −196° C. Alternatively, if the fast-freezing method uses dry ice to stabilise the foamed coffee solution, then the solution may be fast-frozen to about −79° C. Preferably the stabilised foamed coffee solution (e.g. solid coffee block format) is stored at −80° C. to −40° C., or about −60° C. In some embodiments the step of fast-freezing is prior to an additional step of further releasing the pressure. For example, the method may comprise releasing the pressure to provide a foamed coffee solution (e.g. 15 to 25 bars), followed by a step of fast-freezing (e.g. stabilisation with liquid nitrogen), followed by a further release of pressure (e.g. to 1 bar).

In some embodiments the method of producing the instant coffee powder may comprise a step of drying the foamed coffee solution or stabilised foamed coffee solution (e.g. solid coffee block format) to produce a dried coffee. In preferred embodiments the dried coffee is in a dried solid coffee block format. In the step of drying the (stabilised) foamed coffee solution, any method known to those of skill in the art may be used, for example spray- or freeze- drying. In preferred embodiments the step of drying the (stabilised) foamed coffee solution is freeze-drying. Preferably, the freeze-drying reduces and/or avoids rapid sublimation of water in the system, thereby reducing and/or avoiding coalescence of small gas pockets. Suitable freeze-drying methods to reduce and/or avoid rapid sublimation of water will be well known to those of skill in the art. In some embodiments the drying rate is 1° C./hour until the (stabilised) foamed coffee solution reaches 0° C., preferably wherein the initial temperature of the (stabilised) foamed coffee solution is −60° C. to −20° C., preferably about −40° C.

In the step of grinding the dried coffee (e.g. dried solid coffee block format), any method known to those of skill in the art may be used. The step of grinding the dried coffee (e.g. dried solid coffee block format) may further comprise a step of sieving the ground dried coffee to provide an instant coffee powder. After grinding (and optionally sieving) the instant coffee powder may for example consist of granules that have an average diameter of greater than 0.5 mm and/or less than 4 mm. Preferably, the instant coffee powder granules may have an average diameter of about 3 mm.

Thus, in some embodiments the method for producing an instant coffee powder comprises:
(a) mixing a coffee slurry comprising gas hydrates with a second coffee solution to provide a coffee slurry/coffee solution mix;
(b) releasing the pressure of the coffee slurry/coffee solution mix to provide a foamed coffee solution;
(c) fast freezing the foamed coffee solution to provide a stabilised foamed coffee solution;
(d) optionally further releasing the pressure;
(e) drying the stabilised foamed coffee solution, preferably freeze-drying, to provide a dried coffee; and
(f) grinding the dried coffee, to provide an instant coffee powder.

### Instant Coffee Powder

By “instant coffee powder” is meant a dried powder composition which can be reconstituted by addition of a liquid, e.g. hot or cold water, milk, etc. The instant coffee powder may consist of coffee solids, for example soluble coffee solids. Coffee solids are compounds, excluding water, obtained from coffee, for example roasted coffee. Soluble coffee solids are water-soluble compounds which have been extracted from coffee beans, typically using water and/or steam. High levels of coffee solids may be extracted from roasted coffee by aqueous extraction at temperatures above 100° C., for example temperatures between 130° C. and 180° C., where partial hydrolysis of the coffee occurs releasing soluble polysaccharides.

The instant coffee powder of the present invention preferably forms foam and/or crema on its upper surface when reconstituted with water i.e. it may be considered a “foaming instant coffee powder”. By “crema” is meant the thick, reddish-brown foam formed on the surface of espresso. The crema may contain solid particles (insoluble coffee sediments), and its continuous phase is an oil in water emulsion. In the typical regular espresso coffee cup volume (serving) of 25-30 mL, crema represents at least 10% of the total volume (Navarini, E. Illy, Food biophysics 2011, volume 6, issue 3, pp:335-348). In some embodiments the foam and/or crema confers advantageous organoleptic properties, for example improved mouthfeel and/or aroma. In some embodiments the foam and/or crema produced by the instant coffee powder of the present invention has improved texture, stability and/or has a greater volume.

The instant coffee powder of the present invention preferably requires no additional foaming or crema-forming agents to form foam and/or cream on its upper surface. Thus, the instant coffee powder of the present invention preferably comprises no additional foaming or crema-forming agents (i.e. the instant coffee powder of the present invention may be a pure instant coffee powder).

“Porosity” of an instant coffee powder is a measure of the void spaces (pores) and is a fraction of the volume of pores over the total volume of the instant coffee powder, with values of between 0 and 1, or as a percentage between 0% and 100%.

“Closed porosity” is the fraction of the total volume of closed pores in the instant coffee powder. “Open porosity” is the fraction of the total volume of open pores in the instant coffee powder.

“Foaming porosity” is a measure of the porosity which contributes to foaming and characterises the potential foaming ability of the instant coffee powder of the invention. Closed pores will contribute to the foaming. Open pores will not contribute to the foaming as much, or even in some cases not at all compared to closed pores. Pores with an opening diameter of less than 2 micrometres may contribute to foaming since the capillary pressure in these pores is greater than the ambient pressure and this may enable foam formation. Thus, the foaming porosity may be determined by including closed pores and open pores having an opening diameter of less than 2 micrometres. The foaming porosity is obtained by the ratio of the volume of pores contributing to foaming over the volume of the aggregate excluding the volume of open pores having an opening diameter above 2 micrometres.

The size of pores in the instant coffee powder is given by a “pore size distribution”. The pore size distribution may be defined by the incremental volume as a function of pore diameter and/or defined by the number of pores as a function of pore diameter.

The size of closed pores in the instant coffee powder is given by a “closed pore size distribution”. The closed pore size distribution may be defined by the incremental volume as a function of closed pore diameter and/or defined by the number of closed pores as a function of closed pore diameter.

The porosity, closed porosity, open porosity, foaming porosity, pore size distribution, foaming pore size distribution, and closed pore size distribution can be measured by any means known in the art. For example, they can be measured by standard measurements such as mercury porosimetry, x-ray tomographic techniques, SEM and/or methods described in the Examples. The pore size can be determined for example by inspection of SEM images, e.g. with the aid of image analysis software.

In some embodiments the instant coffee powder of the present invention has a total porosity (closed and open) of 60% to 90%, or 70% to 90%, or 70% to 85%, or about 78%.

In some embodiments the instant coffee powder of the present invention has a foaming porosity of 10% to 60%, 15% to 50%, 15% to 34%, or 20% to 34% or, 25% to 34%, or 30 to 34%, or about 25%, 26%, 27%, 28%, 29%, 30%, 31%, 32%, 33%, or 34%, preferably about 30%, preferably wherein the closed pores and open pores having an opening diameter of less than 2 micrometres were formed from a coffee slurry comprising mixed CO₂/N₂ hydrate. In some other embodiments the instant coffee powder of the present invention has a foaming porosity of 10% to 20%, preferably wherein the closed pores and open pores having an opening diameter of less than 2 micrometres were formed from a coffee slurry comprising CO₂ hydrate.

In some embodiments the instant coffee powder of the present invention has a closed porosity of 10% to 60%, 15% to 50%, or 20% to 35%, or 20% to 34%, or 25% to 34%, or 30% to 34%, or about 25%, 26%, 27%, 28%, 29%, 30%, 31%, 32%, 33%, 34% or 35%, preferably about 30%, preferably wherein the closed pores were formed from a coffee slurry comprising mixed CO₂/N₂ hydrate. In some other embodiments the instant coffee powder of the present invention has a closed porosity of 10% to 20%, preferably wherein the closed pores were formed from a coffee slurry comprising CO₂ hydrate.

In some embodiments the instant coffee powder of the present invention has a bimodal pore distribution. A bimodal pore distribution is a continuous pore size distribution with two different modes (i.e. average sizes). Preferably the bimodal pore distribution comprises two Gaussian pore distributions, wherein the modes are approximately equal to the mean values of the Gaussian pore distributions.

In some embodiments the bimodal pore distribution is a bimodal foaming pore distribution. A bimodal foaming pore distribution is a continuous pore size distribution, for closed pores and open pores having an opening diameter of less than 2 micrometres (i.e. foaming pores), with two different modes.

The bimodal pore distribution may comprise (i) pores with an average (modal) diameter of 20 to 100 microns, or 20 to 50 microns, or 25 to 45 microns, or 30 to 45 microns, or 35 to 45 microns, or about 40 microns; and (ii) pores with an average (modal) diameter of less than about 20 microns, or less than about 15 microns, or less than about 10 microns, or less than about 5 microns, or 1-20 microns, or 1-18 microns, or 1-15 microns, or 1-10 microns, or 1-5 microns, or 2-20 microns, or 2-18 microns, or 2-15 microns, or 2-10 microns, or 2-5 microns, or 5-20 microns, or 5-18 microns, or 5-15 microns, or 5-10 microns, or about 2 microns, or about 5 microns, or about 10 microns, or about 15 microns, or about 20 microns. In preferred embodiments the bimodal pore distribution comprises (i) pores with an average (modal) diameter of about 20 to 50 microns; and (ii) pores with an average (modal) diameter of less than about 20 microns (e.g. about 1, 2, 3, 4, 5, 6, 7, 8, 9, 10, 11, 12, 13, 14, 15, 16, 17, 18 or 19 microns). In other preferred embodiments the bimodal pore distribution comprises (i) pores with an average (modal) diameter of about 25 to 45 microns; and (ii) pores with an average (modal) diameter of less than about 20 microns (e.g. about 1, 2, 3, 4, 5, 6, 7, 8, 9, 10, 11, 12, 13, 14, 15, 16, 17, 18 or 19 microns), or about 2 to 20 microns, or about 5 to 15 microns. When the instant coffee powder is produced using a coffee slurry comprising CO₂/N₂ hydrate, the larger pores may be formed by CO₂ and the smaller pores may be formed by N₂. The larger pores may consist of open pores (including foaming pores) and/or closed pores, preferably the larger pores substantially consist of open pores (i.e. >90%, >95%, >99% or about 100% of the larger pores are open pores), most preferably the open pores are open pores with opening diameter of 2 micrometres or greater. The smaller pores may consist of closed pores and/or foaming pores (i.e. open pores having an opening diameter of less than 2 micrometres), preferably the smaller pores substantially consist of closed pores (i.e. >90%, >95%, >99% or about 100% of the smaller pores are closed pores).

In some embodiments the larger pores contribute 10 to 99% by volume of the total pore volume and/or the smaller pores contribute 1 to 90% by volume of the total pore volume. In some other embodiments the larger pores contribute 10 to 90% by number of the total pores and/or the smaller pores contribute 10 to 90% by number of the total pores. The volume and/or number of the total pores contributed by each mode may be estimated based on the pore size distribution. A pore size distribution may be estimated for each mode and the contribution calculated based on the total pore size distribution. For example, preferably the bimodal pore distribution comprises two Gaussian pore distributions, thus the respective areas of the Gaussian distribution for each mode may be used to calculate the volume and/or number of the total pores contributed by each mode.

In preferred embodiments the instant coffee powder of the present invention has a bimodal closed pore distribution. Thus, in some embodiments the bimodal pore distribution is a bimodal closed pore distribution. A bimodal closed pore distribution is a continuous closed pore size distribution with two different modes.

In some embodiments the bimodal closed pore distribution comprises (i) closed pores with an average (modal) diameter of 20 to 100 microns, or 20 to 50 microns, or 25 to 45 microns, or 30 to 45 microns, or 35 to 45 microns, or about 40 microns; and (ii) closed pores with an average (modal) diameter of less than about 20 microns, or less than about 15 microns, or less than about 10 microns, or less than about 5 microns, or 1-20 microns, or 1-18 microns, or 1-15 microns, or 1-10 microns, or 1-5 microns, or 2-20 microns, or 2-18 microns, or 2-15 microns, or 2-10 microns, or 2-5 microns, or 5-20 microns, or 5-18 microns, or 5-15 microns, or 5-10 microns, or about 2 microns, or about 5 microns, or about 10 microns, or about 15 microns, or about 20 microns. In preferred embodiments the bimodal closed pore distribution comprises (i) closed pores with an average (modal) diameter of about 20 to 50 microns; and (ii) closed pores with an average (modal) diameter of less than about 20 microns (e.g. about 1, 2, 3, 4, 5, 6, 7, 8, 9, 10, 11, 12, 13, 14, 15, 16, 17, 18 or 19 microns). In other preferred embodiments the bimodal closed pore distribution comprises (i) closed pores with an average (modal) diameter of about 25 to 45 microns; and (ii) closed pores with an average (modal) diameter of less than about 20 microns (e.g. about 1, 2, 3, 4, 5, 6, 7, 8, 9, 10, 11, 12, 13, 14, 15, 16, 17, 18 or 19 microns), or about 2 to 20 microns, or about 5 to 15 microns. When the instant coffee powder is produced using a CO₂/N₂ hydrate, the larger closed pores may be formed by CO₂ and the smaller closed pores may be formed by N₂.

In some embodiments the larger pores contribute 10 to 99% by volume of the total closed pore volume and/or the smaller pores contribute 1 to 90% by volume of the total closed pore volume. In some other embodiments the larger pores contribute 10 to 90% by number of the total closed pores and/or the smaller pores contribute 10 to 90% by number of the total closed pores. The volume and/or number of the total closed pores contributed by each mode may be estimated based on the closed pore size distribution. A closed pore size distribution may be estimated for each mode and the contribution calculated based on the total closed pore size distribution.

In some embodiments the instant coffee powder of the present invention has a foaming porosity of 15% to 34%, or 20% to 34% or, 25% to 34%, or 30 to 34%, or about 30%, and a bimodal pore distribution.

In some embodiments the instant coffee powder of the present invention has a foaming porosity of 15% to 34%, or 20% to 34% or, 25% to 34%, or 30 to 34%, or about 30%, and a bimodal pore distribution, wherein the bimodal foaming pore distribution comprises (i) pores with an average (modal) diameter of 20 to 100 microns and (ii) pores with an average (modal) diameter of less than about 20 microns, preferably wherein (i) contributes 10 to 99% by volume of the total pore volume and/or (ii) contributes 1 to 90% by volume of the total pore volume. Preferably the larger pores substantially consist of open pores and the smaller pores substantially consist of closed pores.

In some embodiments the instant coffee powder of the present invention has a foaming porosity of 20% and 34% and a bimodal pore distribution, wherein the bimodal pore distribution comprises (i) pores with an average (modal) diameter of 25 to 45 microns and (ii) pores with an average (modal) diameter of less than about 20 microns (e.g. about 1, 2, 3, 4, 5, 6, 7, 8, 9, 10, 11, 12, 13, 14, 15, 16, 17, 18 or 19 microns), or about 2 to 20 microns, or about 5 to 15 microns, preferably wherein (i) contributes 10 to 99% by volume of the total pore volume and/or (ii) contributes 1 to 90% by volume of the total pore volume. Preferably the larger pores substantially consist of open pores and the smaller pores substantially consist of closed pores.

In preferred embodiments the instant coffee powder of the present invention has a closed porosity of 20% to 40%, or 20% and 34%, and a bimodal pore distribution.

In other preferred embodiments the instant coffee powder of the present invention has a closed porosity of 20% to 40%, or 20% and 34%, and a bimodal pore distribution, wherein the bimodal pore distribution comprises (i) pores with an average (modal) diameter of 20 to 100 microns and (ii) pores with an average (modal) diameter of less than about 20 microns, preferably wherein (i) contributes 10 to 99% by volume of the total pore volume and/or (ii) contributes 1 to 90% by volume of the total pore volume. Preferably the larger pores substantially consist of open pores and the smaller pores substantially consist of closed pores.

In other preferred embodiments the instant coffee powder of the present invention has a closed porosity of 20% and 34% and a bimodal pore distribution, wherein the bimodal pore distribution comprises (i) pores with an average (modal) diameter of 25 to 45 microns and (ii) pores with an average (modal) diameter of less than about 20 microns (e.g. about 1, 2, 3, 4, 5, 6, 7, 8, 9, 10, 11, 12, 13, 14, 15, 16, 17, 18 or 19 microns), or about 2 to 20 microns, or about 5 to 15 microns, preferably wherein (i) contributes 10 to 99% by volume of the total pore volume and/or (ii) contributes 1 to 90% by volume of the total pore volume. Preferably the larger pores substantially consist of open pores and the smaller pores substantially consist of closed pores.

Advantageously, the larger (open) pores in the instant coffee powder are beneficial for the easy reconstitution of the sample making the coffee accessible for water penetration. Advantageously, the smaller (closed) pores in the instant coffee powder are beneficial for generation of the foam or crema.

In some embodiments the instant coffee powder further comprises open pores, which may be formed by ice crystals and sublimation during freeze-drying.

The instant coffee powder may be for providing a coffee beverage with a crema of at least 0.25 ml/g on reconstitution with water, for example a crema of at least 0.75 ml/g on reconstitution with water.

The instant coffee powder may consist of granules. Preferably, the instant coffee powder granules have an average diameter of greater than 0.5 mm. Preferably, the instant coffee powder granules have an average diameter of less than 4 mm. Most preferably, the instant coffee powder granules have an average diameter of about 3 mm. The average granule diameter may for example be measured by calibrated sieves.

The terms “comprising”, “comprises” and “comprised of” as used herein are synonymous with “including” or “includes”; or “containing” or “contains”, and are inclusive or open-ended and do not exclude additional, non-recited members, elements or steps. The terms “comprising”, “comprises” and “comprised of” also include the term “consisting of”.

As used herein the term “about” means approximately, in the region of, roughly, or around. When the term “about” is used in conjunction with a numerical value or range, it modifies that value or range by extending the boundaries above and below the numerical value(s) set forth. In general, the terms “about” and “approximately” are used herein to modify a numerical value(s) above and below the stated value(s) by 10%.

### EXAMPLES

### Example 1—Characterisation of Gas Solubility in Coffee Solutions, Phase Diagrams of Coffee Solution-Gas Systems, and Rheology of Coffee Solutions

### Gas Solubility in Coffee Solutions

Gas solubility in coffee solutions was assessed experimentally with a tempered high-pressure vessel reactor and a pressure sorption decay method, monitoring the gas consumption from the headspace with a third polynomial gas equation of state. The experiments were performed at 4° C. and 10, 20, 30, 35 bar and at 10° C. and 10, 20, 30, 35, 40 bar. The initial loading was 100 g of either 30 or 50 wt % coffee solution.

FIG. 2 and Table 1 show the experimental results for CO₂ solubility in coffee solutions. At 35 bar and 4° C., 38.6 mg/g of CO₂ was dissolved in a 30 wt % coffee solution. The 30 wt % coffee solution was also tested with N₂ at 4° C. and 10° C. At 35 bar and 4° C., 0.7 mg/g and at 50 and at 4° C. bar 2.94 mg/g were dissolved. At 10° C. no dissolution of N2 in the 30 wt % coffee solutions could be detected.

TABLE 1
Comparison of CO₂ solubilities in milligrams of gas per grams
of solute for 30 wt % coffee

| | Temp, | Solubility | Solubility | Solubility |
|---|---|---|---|---|
| System | tested | at 30 bar | at 20 bar | at 10 bar |
| Coffee solution 30 wt % | 4° C. | 34.7 mg/g | 24.6 mg/g | 17.3 mg/g |
| Coffee solution 30 w t% | 10° C. | 29.8 mg/g | 21 mg/g | 15.8 mg/g |

### Coffee Solution-CO₂ and Coffee Solution-N₂ Phase Diagrams

The phase diagram for obtaining the coffee solution/CO₂ hydrate-liquid-vapour (H-L-V) stability line was estimated with the isochoric multi-step heating/cooling dissociation temperature-cycle method in a high-pressure stirred vessel reactor and high-pressure differential scanning calorimetry (DSC) method.

FIG. 3a shows the resulting equilibrium points for the 30 wt % coffee solution-CO₂ system. The obtained points fall between the pure water and 25 wt % sugar solution hydrate-liquid-vapour boundary zones suggesting the well described 25 wt % sugar solution as a suitable model for the 30 wt % coffee solution.

FIG. 3b includes a phase diagram for mixed hydrates with CO₂/N₂ guests in water adapted from literature (Kang, S. P., et al., 2001. The Journal of Chemical Thermodynamics, 33(5), pp. 513-521). The hydrate-liquid-vapour boundary lines are represented for various CO₂ compositions, which lie between the boundaries for single CO₂ (2-digit pressure values in bar) and N₂ hydrates (3-digit pressure values in bar).

### Rheology of Coffee Solutions

The viscosity of coffee solutions of 30, 40, 50 and 60 wt % were measured. FIG. 4 shows the results from rheological characterization of coffee solutions.

The viscosity dependency on shear rate in FIG. 4a were the same at atmospheric pressure and at 30 bar. On a shear rate scale from 10 to 1000 s⁻¹, the material could be classified as a Newtonian fluid. With the 60 wt % coffee concentrate, mostly used on the main stream line, the viscosity was around 2.3 Pas at 30 bar. For the 30 wt % mix, mostly used on the high-pressure clathrate hydrate slurry generator (CLAG) reactor, the viscosity was around 14 to 16 mPas. This corresponded with the flow meter measurements on the high-pressure CLAG reactor before CO₂ dissolution. During gas dissolution on the high-pressure CLAG reactor, viscosity values rose up to 30 mPas for 30 wt % coffee solutions at temperatures around 5° C. and up to 60 mPas during hydrate growth. The rise in the viscosity values indicated gas dissolution and embedding into the gas hydrate cages.

FIG. 4b shows the viscosity dependence on temperature. A trend of decreasing viscosity with increasing temperature was seen.

### Example 2—Production of Coffee Slurries Comprising Gas Hydrates

For producing coffee slurries comprising gas hydrates, several combinations of gas types and amounts were tested in the high pressure clathrate hydrate slurry generator (CLAG) reactor. Coffee slurries with dissolved gas not comprising gas hydrates were also tested for comparison with the gas hydrate system. A complete list of experiments is given in table 3.

TABLE 3
Main experimental conditions and materials investigated on the
high pressure clathrate hydrate slurry generator (CLAG) reactor

| | | | T on the | | | Continuous |
|---|---|---|---|---|---|---|
| | Gas in | | CLAG | Coffee | | phase in the |
| | CLAG | Hydrate | reactor | solids in | | CLAG |
| Trial | reactor | presence | chiller | main stream | | reactor |
| 1 | CO₂ | yes | 0° C. | 55 | wt % | 10 wt % |
| | | | | | | coffee sol. |
| 2 | CO₂ | yes | 0° C. | 55 | wt % | 20 wt % |
| | | | | | | coffee sol. |
| 3 | CO₂ | yes | 0° C. | 55, 60 | wt % | 30 wt % |
| | | | | | | coffee sol. |
| 4 | N₂ | no | −5° C. | 60 | wt % | 30 wt % |
| | | | | | | coffee sol. |
| 5 | CO₂/ | yes | −5° C., | 60, 63, 65 | wt % | 30 wt % |
| | N₂ mix | | −8° C. | | | coffee sol. |
| 6 | CO₂ | — | −5° C. | — | | 50 wt % |
| | | | | | | coffee sol. |
| 7 | CO₂ | no | 7° C. | 55 | wt % | 30 wt % |
| | | | | | | coffee sol. |

### CO₂ Hydrate Coffee Slurries

The typical protocol for generating a CO₂ hydrate slurry from a coffee solution in the high-pressure clathrate hydrate slurry generator (CLAG) reactor consisted of several steps. The high-pressure CLAG reactor was filled with 3 liters of the 30 wt % coffee solution. Simultaneously, a defined amount of gas (50-400 g) was filled into the gas reservoir cylinder (pressure up to 35 bar). The SSHE unit was spun at 800 rpm and the pump at 40 to 50 Hz (up to 330 L·h⁻¹). The whole high-pressure CLAG reactor was cooled down to a temperature region within or outside of the gas hydrate stability zone ranging from 7° C. to −8° C. Afterwards the high-pressure CLAG reactor was pressurized from the gas reservoir. After supersaturation was achieved, gas hydrates were formed after at a certain time. This time, when gas hydrates first appeared is called the induction point. The time to the induction point is called the induction time. After the induction point, the gas hydrates entered the growth phase.

Highly viscous initial coffee solutions were desirable to reduce the amount of water for specific foaming applications. However, higher viscosity slurries (0.3 Pas) were difficult to pump. Thus, the 30 wt % coffee solution was chosen for the transfer experiments.

### CO₂:N₂ Hydrate Coffee Slurries

For the trials, where gas hydrates were formed with CO₂ and N₂, ratios of up to 0.64 CO₂:N₂ were tested. CO₂ ratios between 0.47 and 0.54 had a homogeneous flow profile after gas hydrate formation and were easy to handle. After forming a small amount of gas hydrates in the coffee solution with CO₂ at pressures around 20 bar, N₂ was added by pressurizing to 35 bar of pressure assuming the non-occupied hydrogen bonded cages could be further filled up by smaller N₂ molecules.

### High-Pressure CLAG Reactor Conditions for Transfer Trials

FIG. 5 and Table 4 show the decreasing density and increasing viscosity trends in the high-pressure CLAG reactor trials after gas hydrate appearance for CO₂ and CO₂:N₂ hydrate coffee slurries.

TABLE 4
Comparison of 30 wt % coffee gas hydrate slurries.

| | 30 wt % Coffee | 30 wt % Coffee solution |
|---|---|---|
| System | solution CO₂ | CO₂/N₂ = 0.54 |
| η at atm. p, at 500s⁻¹ | 14.5 mPas at 7° C. | 14.5 mPas at 7° C. |
| η CO₂ sol. | 29.7 ± 7 mPas | 14 ± 1 mPas |
| ρ CO₂ sol. | 0.94 kg/L | 1.034 kg/L |
| η with CO₂ H | 59.8 ± 6.5 mPas | 14.6 ± 1.6 mPas |
| ρ with CO₂ H | 0.819 kg/L | 1.034 kg/L |
| η with CO₂/N₂ H | — | 24 ± 3 mPas |
| ρ with CO₂/N₂ H | — | 0.913 kg/L |
| at p, T | 30 bar, 5.5° C. | 35 bar, 2.8° C. |
| induction time | 1800 ± 300 s | 3400 ± 300 s |

The pressure and temperatures in the last row are given for the condition before the gas hydrate slurry transfer into the EGLI main stream line.
The pressure on the high-pressure CLAG reactor for the CO₂/N₂ experiments before the nitrogen injection was around 19 bar.
H stands for hydrate, p for pressure, T for temperature.

The viscosity increase and density decrease with gas dissolution was less pronounced for trials where no hydrates were present, indicating less gas consumption. To a certain extent, the density and viscosity could report about the increase in clathrate matter in the slurry.

To achieve an estimate about the gas distribution in the coffee slurry trials, the coffee in the system was neglected and the occupancy, hydration number and the volumetric fractions of the phases present were calculated only for the water in the system using the Colorado school of Mines CSMGEM gas hydrate software (Sloan, E. D. and C. A. Koh: Clathrate Hydrates of Natural Gases. p. 752, 2007). For the 30 wt % coffee solution with CO₂, a 50% occupancy and a hydration number of 11.5 was used and taken as a lower range estimate concerning the cage occupancy (see Teng, H, et al., Chemical Engineering Science, 50(4):559-564, 1995). With observations made by Kang et al. (Kang, S. P., et al., 2001. The Journal of Chemical

Thermodynamics, 33(5), pp. 513-521) and the phase diagram it was also possible to estimate the amount of CO₂/N₂ in the hydrate at process conditions. Due to low pressures and the given CO₂/N₂ loading, about 2% of nitrogen were embedded in the hydrate, the rest being carbon dioxide. The results are presented in table 5.

TABLE 5
Example of CO₂ and N₂ gas distribution in 3 L of a coffee slurry obtained from a
30 wt % coffee solution for hydrate and non hydrate conditions in the
high-pressure CLAG reactor. The phase fractions are volumetric, L stands for
liquid that is water, H stands for hydrate. The pressure temperature working
conditions for given cases are shown. *This case regards liquid as coffee
solution (treated with the thermodynamic model).

| | | | CO₂ moles | CO₂ moles | N₂ moles | N₂ moles |
|---|---|---|---|---|---|---|
| | H | L | in Hydrate | in Liquid | in Hydrate | in Liquid |
| System | fraction | fraction | phase | phase | phase | phase |
| CO₂ H, 30 bar, 5° C.* | 0.25 | 0.75 | 3.3 | 1.4 | — | — |
| CO₂ H, 30 bar, 5° C. | 0.34 | 0.66 | 3.7 | 1.1 | | |
| CO₂/N₂ H, 35 bar, 3° C. | 0.12 | 0.88 | 1.8 | 1 | 0.05 | 0.09 |
| CO₂ dissolved | — | 1 | — | 2.1 | — | — |
| N₂ dissolved | — | 1 | — | — | — | 0.14 |

### Example 3—Production of Instant Coffee Powder

### Transfer of Coffee Slurry to Main Stream EGLI Line

When gas hydrates appeared in the coffee slurry and the system was in equilibrium or when the system was fully saturated with gas, the slurry was transferred to the main stream EGLI line with the settings given in table 6. The main stream consisted of a modified EGLI (EGLI AG) margarine pilot plant with separate surface scraped heat exchanger (SSHE) units. The main stream line was supplied with concentrates containing up to 65 wt %.

TABLE 6
Average settings on the main stream EGLI line used during the coffee
trials. H stands for hydrate, diss. stands for dissolved.

| Foaming | p EGLI | T EGLI | T after | | T EGLI | | Dosing | | |
|---|---|---|---|---|---|---|---|---|---|
| with | outlet | inlet | 1^{st} unit | | outlet | | interval | SSHE 1 | SSHE 2 |
| CO₂ H | 27.1 bar | 7.1° C. | 0.9° | C. | −6° | C. | 10 to 120 s | 240 rpm | 180 rpm |
| CO₂/N₂ H | 31.8 bar | 5.5° C. | 0.9° | C. | −4.5° | C. | 10 to 120 s | 240 rpm | 180 rpm |
| N₂ diss. | 21.6 bar | 7.6° C. | 5.2° | C. | −2.2° | C. | 10 s | 750 rpm | 600 rpm |
| CO₂ diss. | 26.4 bar | 6.2° C. | 0° | C. | −5.2° | C. | 10 s | 300 rpm | 200 rpm |

The average dosing rate for the transfer was 15.3 cm³ dosed every 5 to 30 s, when N₂ was involved and every 60 to 100 s seconds for gas hydrate slurries. The opening of the valve was in general 1 s. Overruns high as 500% were easily achieved. A standard overrun was in the range of 100 to 200% across all used foaming media. The majority of experiments were done with a 60 wt % coffee solution on the main stream line.

A typical gas hydrate slurry transfer is shown on FIG. 6a and compared with a situation, where dissolved N₂ in coffee was dosed (FIG. 6b).

For the N₂ trial, the solution had to be dosed frequently and the mixture in the high-pressure CLAG reactor was therefore depleted faster over the dosing process. With solutions not containing gas hydrates and only containing dissolved gas in the high-pressure CLAG reactor, it was in general more difficult to regulate the back-pressure on the main stream line as the CLAG reactor pressure fluctuated with more gasified coffee solution needed to be dosed. Higher doses (higher dosing frequency or longer valve opening) from the high-pressure CLAG reactor and higher scraper speeds on the surface scraped heat exchanger units on the EGLI were necessary for the dissolved gas coffee slurries when compared with gas hydrate containing slurries, see also table 6.

### Fast Freeze Stabilisation

The trials resulted in a foamed coffee slurry, which was stabilized to maintain its porosity and gas retention until the freeze-drying step. Fast freeze stabilization avoiding any further gas bubble expansion or coalescence beyond the expansion valve of the EGLI is preferred. For stabilization, the following approaches were applied:
Capturing the product on solid CO₂ pellets at −78.5° C. stabilizing the foam microstructure.
Capturing the product directly into liquid nitrogen at −195.79° C. assuming a quenching effect.
Capturing the product at elevated pressures of 15 to 20 bar into a pre-pressurized precooled 1 L vessel from Kisag (Bellach, CH) and rapidly cooling its contents with dried ice or liquid nitrogen. A partial expansion of the product is assumed, given the fact, that the conditions in the pressure/temperature main stream line are to some extent retained. In this way gas hydrates could be preserved.
Capturing the product on a 1 cm thick aluminium plate previously immersed in liquid nitrogen. A slower heat transfer is assumed compared to the direct liquid nitrogen quenching.
First annealing in a two-step manner at −25° C. and at temperatures close to the freezing point depression of the 60 wt % coffee solution (−16° C.) and then storing the samples at −60° C., achieving so a gentle freezing profile inducing ice crystal growth, which could play a role in the freeze drying of the specimen. The annealing was done in a freezer box for one hour, then slowly brought back to a temperature around the melting point in a cooling box from Vebabox (Uden, NL) before storing −60° C.

After the samples were stabilized, they were stored in a freezer held at −60° C.

### Freeze Drying

The samples were subsequently freeze dried. Table 7 demonstrates a typical freeze drying profile conducted in a Millrock Technology freeze drier, (Kingston, USA). The freeze drying was intentionally done with a long delicately designed drying process to avoid rapid sublimation of water in the system, causing coalescence of small gas pockets.

TABLE 7
Freeze drying profile steps and their temperature profiles for drying
of frozen coffee foamed products from the clathrate transfer process

| Freeze | | | | | |
|---|---|---|---|---|---|
| drying | | Starting | End | Drying | Time, |
| step | Step description | temp, ° C. | temp, ° C. | rate, ° C./h | h |
| Freezing | Equilibration to | −40 | −40 | 0 | 14 |
| | initial temp. | | | | |
| Primary | 1^{st} heating ramp | −40 | −20 | 1 | 20 |
| drying | 2^{nd} heating ramp | −20 | 0 | 1 | 20 |
| | 3^{rd} heating ramp | 0 | 40 | 4 | 10 |
| Secondary | | 40 | 25 | 5 | 3 |
| drying | | | | | |

### Example 4—Characterisation of Deep Frozen and Freeze Dried Coffee Samples

### Crema Formation

FIG. 7 shows examples of reconstituted freeze-dried samples and their crema generation performance. For this 1.6 g sample of instant coffee granules (ca 3 mm) were reconstituted with 150 ml of water at 85° C.

The total porosity of the samples was 78%±9 and was comparable with a reference instant coffee product, which had a porosity of 72.7%.

Closed porosity is more insightful, as it gives information related to crema formation. Closed small pores containing air evolved after freeze drying of the stabilised foamed coffee solution. These get released when the porous instant coffee powders are reconstituted with hot water. A reference instant coffee product had a closed porosity of 61.2% with all closed pores in the range of <5 to 20 μm, delivering a crema layer. A conventional instant coffee product compared to that has a closed porosity of 6.2%, delivering no crema. The instant coffee powders from this study therefore significantly contributed to improving the crema formation from instant coffee powders.

The highest closed porosity achieved for an instant coffee product produced using a CO₂ hydrate slurry was 18.9%, see FIG. 7a. The best crema appeared (for an instant coffee product produced using a CO₂ hydrate slurry) with a closed porosity of 15.7% and a high overrun of 164%.

Nitrogen was introduced to decrease the size of the pores. All samples where N₂ was involved had higher closed porosities than the CO₂ hydrate slurries. The most successful instant coffee product produced using a mixed CO₂/N₂ hydrate slurry, with respect to crema, had a closed porosity of 32%.

From the given examples, it could be concluded, that high overruns, high porosities (e.g. high total, foaming and/or closed porosities), and small closed pores (due to nitrogen in mixed gas hydrates e.g. CO₂/N₂>0.54) perform best in crema generation.

### Pore Distribution

FIG. 8 shows the best sample with respect to crema from FIG. 7b with an overrun of 218% formed from a CO₂/N₂ hydrate.

The SEM images feature a bimodal pore distribution with smaller pores <20 μm and larger pores −50 μm. The small, mostly closed pores resemble the reference image formed only from N₂ and are attributed to N₂ evolving from the hydrate structure. The larger pores on the other hand were attributed to CO₂ and are beneficial for the easy reconstitution of the sample making the coffee accessible for water penetration. Thus, despite having a closed porosity of two times lower than the reference, the sample still delivered a crema layer.

FIG. 9 show samples, which were analysed with cryo-SEM after being withdrawn from the main stream EGLI line and stabilized. The first sample with dissolved N₂ has a low overrun of 43%, but the pores are very small and closed. Another image with a CO₂/N₂ gas ratio of 0.55 features a fraction of very small closed pores and a higher overrun of 151%.

The last two examples on FIG. 9 were examples with a 250× magnification with high CO₂ loadings with no N₂ involved. One sample was a foamed 60 wt % and the other one a 55 wt % concentrate. The 55 wt % coffee concentrate foamed with CO₂ formed a foam with slightly larger pores than the 60 wt % coffee concentrate sample. There were no effects observed on the type of stabilization of the foamed coffee solution with respect to crema formation.

These results suggest that ideally the coffee concentrate should be foamed with nitrogen hydrates, for which however high pressures are needed (up to 300 bars).

For a sustainable process at lower pressures, CO₂ hydrates or mixed CO₂/N₂ hydrates are good alternatives for producing instant coffee products capable of delivering a crema layer. The use of CO₂ hydrates or mixed CO₂/N₂ hydrates allows for a flexible and rapid freeze drying temperature profile desired in industrial applications and lowering the operational pressure compared to pure nitrogen hydrates.

Moreover, molecularly embedded nitrogen in the mixed CO₂/N₂ hydrates seems to create a similar structure as dissolved nitrogen at high pressures (>150 bar) as seen in the reference sample. The nitrogen fraction in the mixed hydrates may be increased by shifting the operating conditions towards higher pressures and lower temperatures, increasing the closed porosity in freeze dried products stemming from N₂.

An advantage of using gas hydrates compared to a method which uses dissolved gas (i.e. the method used to produce the reference sample), is that lower amounts of gas are needed to produce an instant coffee product capable of delivering a crema layer. Also, the time to produce hydrates at moderate pressures (35 to 50 bars) is in the range of minutes, compared to hours for dissolving nitrogen gas.

### Example 5—Methods

### Differential Scanning Calorimetry (DSC)

High-pressure DSC measurements for determining the hydrate-liquid-vapor boundary line for CO₂ hydrates formed from coffee solutions. The device used was the micro DSC VII (1-7721-3) from Setaram (Caluire, France) and the measurements were conducted for 30 and 50 wt % coffee solutions at atmospheric pressure, 10, 30 and 50 bar. Temperatures of the sample and sapphire reference were recorded in the furnace. It was assumed the pressure is constant throughout the measurements. Samples of sizes <100 μg were loaded into specialized high-pressure cells and were pressurized to the given pressure. Afterwards the temperature profile in the table below was applied and repeated in three cycles. The endothermic melting peaks for gas hydrate dissociation were identified and the onset temperature was taken as CO₂ hydrate equilibrium point.

| Segment | T in ° C. | Rate |
|---|---|---|
| 1 | 10 | Constant 1 hour |
| 2 | 10 to −40 | 0.2° C. min |
| 3 | −40 | Constant 1 hour |
| 4 | −40 to 10 | 0.2° C. min |
| 5 | 10 | Constant 1 hour |

DSC measurements at atmospheric pressure for determining the freezing point depression and molecular weight. Differential scanning calorimetry was used for determining the freezing point depression of coffee solutions and their molecular weight. Triplicate samples were measured on the Mettler Toledo (Ohio, USA) DSC 822e calorimeter for the 30 and 60 wt % coffee solutions. The freezing point depression was evaluated as the onset of an endothermic melting event in the STARe software provided as well by Mettler Toledo. The molecular weight was then calculated using the freezing point depression constant for the water solvent, which is equal to −1.86° C·m⁻¹ (per amount of water solvent). The molecular weight of the coffee powder resulted as 186g·mol⁻¹. The respective freezing point depression was −4.4° C. for the 30 wt % coffee solution and −15.5° C. for the 60 wt % coffee solution.

### Rheology

The viscosity of coffee solutions of 30, 40, 50 and 60 wt % were measured in a MRC 302 rheometer (Anton Paar, Graz, Austria) under 30 bar pressure and at atmospheric pressure using a cylinder cup-bob Couette geometry. Coffee solutions of more than 60 wt % could not be well assessed in the rheometer.

The viscosity dependency on shear rate and temperature was conducted at shear rate ramps ranging from 1 to 1000 s⁻¹ at a constant temperature of 7° C. (excluding the hydrate presence). The measurement was then repeated under a pressure of 30 bars. The viscosity changes with a temperature were conducted from 10° C. to 0° C. with a linear temperature gradient, then held at 0° C. for 5 minutes and ramped back up to 10° C. at the same rate of 2° C.·min⁻¹.

The measured data was fitted using the equation:

$$log ( η ) = A + \frac{B}{T + C}$$

### Characterisation of Freeze Dried Products

The freeze-dried products were ground and sieved to obtain representative granules (3 mm) corresponding to a conventional instant coffee. The density, open and closed porosity and crema development performance were tested.

Density measurements of freeze-dried coffee. The matrix density was determined by a DMA 4500 M apparatus (Anton Paar, Switzerland AG). The sample was introduced into a U-shaped borosilicate glass tube that was excited to vibrate at a frequency depending on the sample. Based on specific oscillation characteristics, the density was determined. The accuracy of the instrument was 5.10⁻⁵ g·cm3 for the density and 0.03° C. for the temperature.

Porosity measurements of freeze-dried coffee. The apparent density of the coffee granulate was measured by the Accupyc 1330 Pycnometer (Micrometrics Instrument Corporation, USA). The instrument determines density and volume by measuring the pressure change of helium in a calibrated volume with an accuracy to within 0.03% of reading plus 0.03% of nominal full-scale cell chamber volume. Open porosity was then calculated from the matrix density and the apparent density, according to the following equation:

$$porosity = 1 - \frac{ρ ( apparent )}{ρ ( matrix )}$$

The closed porosity was similarly as the open porosity measured volumetrically. The freeze dried specimen were analysed on the Geopyc 1360 device (Micromeritics, Norcross, USA). The envelope density was measured by the pycnometer based on a displacement method, where the sample was placed into a matrix of small rigid particles with a high-degree of flow ability. The flowing spheres around the sample (with a known weight) define the open porosity, as they reach the open pores but not the closed pores.

Scanning electron microscopy of stabilized frozen porous coffee specimens (cryo-SEM). The microstructure and pore size was further analysed with cryo-SEM of the stabilized frozen porous coffee specimens. For this, the stabilized samples were stored under liquid nitrogen. Afterwards the samples were broken using a scalpel and then a representative piece was glued using a 60% sugar solution to a sample holder. The preparation was done under liquid nitrogen. The sample holder was inserted into vacuum chamber shuttle manipulator arm used to transfer the sample into the BAF060 cryo-SEM preparation freeze fraction and etching station (Leica Microsystems, Wetzlar Germany) precooled to below −150° C. In the BAF station the samples were fractured to get a fresh surface, this was then etched by subliming superficial ice layers under vacuum to expose some parts that could be hidden due to long sample preparations. The etching was done at −110° C. for 1.5 minutes. The sample was then coated with a carbon-metal mix with a 3 nm layer with a controlled e-beam gun at a 2 kV voltage. The sample was then transferred with the Gatan cryo-vacuum-holder shuttle to the SEM microscope and loaded on the stage. The stigmatism and the aperture were set in the microscope and images acquired at various magnifications.

Scanning electron microscopy of freeze-dried porous coffee specimen (SEM). For the scanning electron microscopy of the freeze-dried samples for porosity investigations, the samples were glued onto a metallic specimen stub equipped with a double-sided conductive tape. When needed the samples were subsequently fractured using a razor blade to reveal their internal structure. The samples were coated with a 10 nm gold layer using a Leica SCD500 sputter coater and images were acquired in a high/low vacuum mode using a Quanta F200 Scanning Electron Microscope from Thermo Fischer Scientific (Waltham, USA).

All publications mentioned in the above specification are herein incorporated by reference. Various modifications and variations of the disclosed methods, compositions and uses of the invention will be apparent to the skilled person without departing from the scope and spirit of the invention. Although the invention has been disclosed in connection with specific preferred embodiments, it should be understood that the invention as claimed should not be unduly limited to such specific embodiments. Indeed, various modifications of the disclosed modes for carrying out the invention, which are obvious to the skilled person are intended to be within the scope of the following claims.

1. (canceled)

2. A method of producing a coffee slurry comprising gas hydrates, comprising:
(a) providing a first coffee solution;
(b) cooling the first coffee solution; and
(c) pressurising the first coffee solution with gas, to provide a coffee slurry comprising gas hydrates, wherein the gas is selected from the group consisting of air, carbon dioxide, nitrogen, nitrous oxide and argon.

3. A method according to claim 2, wherein the first coffee solution is cooled to between −10° C. and 10° C., and the gas pressure is from 10 to 300 bar.

4. A method according to claim 2, wherein the method comprises cooling the first coffee solution to between 0 and 5° C., and pressurising the first coffee solution with carbon dioxide.

5. A method according to claim 2, wherein the method further comprises a step of distributing the gas hydrate in the coffee slurry.

6. A coffee slurry comprising gas hydrates, wherein the gas is selected from the group consisting of air, carbon dioxide, nitrogen, nitrous oxide and argon.

7. A method according to claim 2, wherein the coffee slurry comprises carbon dioxide.

8. A method according to claim 2, wherein the coffee slurry has a ratio of gas in the hydrate fraction to gas in the liquid fraction (H:L) of from 1:1 to 5:1.

9. A coffee slurry according to claim 6, wherein the coffee slurry comprises 10 wt % to 50 wt % coffee solids.

10. A coffee slurry according to claim 6, wherein the coffee slurry has a viscosity of between 10 and 100 mPas.

11. A method of producing an instant coffee powder comprising:
(a) mixing a coffee slurry comprising gas hydrates with a second coffee solution to provide a coffee slurry/coffee solution mix;
(b) releasing the pressure and/or increasing the temperature of the coffee slurry/coffee solution mix to provide a foamed coffee solution;
(c) drying the foamed coffee solution, to provide a dried coffee; and
(d) grinding the dried coffee, to provide an instant coffee powder.

12. (canceled)

13. A method according to claim 11, wherein the coffee slurry comprises carbon dioxide.

14. A method according to claim 11, wherein the second coffee solution comprises 10 wt % to 70 wt %.

15. A method according to claim 11, wherein the coffee slurry is added to the second coffee solution under approximately isobaric-isothermal conditions, wherein the approximately isobaric-isothermal conditions are a temperature of between −10° C. and 10° C.

16. A method according to claim 11, wherein the foamed coffee solution reaches an overrun of from 50 to 500%.

17. A method according to claim 11, wherein in the step of releasing the pressure and/or increasing the temperature of the coffee slurry/coffee solution mix the pressure is released to between 1 bar and 10 bar, and the temperature of the coffee slurry/coffee solution mix is increased to between −5° C. and 10° C.

18. A method according to claim 11, wherein the method comprises an additional step of fast-freezing the foamed coffee solution, prior to drying the foamed coffee solution.

19-21. (canceled)
